(19) United States
(12) Patent Application Publication
(10) Pub. No.: US 2015/0120914 A1
(43) Pub. Date: Apr. 30, 2015

(54) SERVICE MONITORING SYSTEM AND SERVICE MONITORING METHOD

(71) Applicants: Kiyomi Wada, Tokyo (JP); Kiyokazu Saigo, Tokyo (JP)

(72) Inventors: Kiyomi Wada, Tokyo (JP); Kiyokazu Saigo, Tokyo (JP)

(73) Assignee: HITACHI, LTD., Tokyo (JP)

(21) Appl. No.: 14/398,629

(22) PCT Filed: Jun. 13, 2012
(86) PCT No.: PCT/JP2012/065110

§ 371 Date: Nov. 3, 2014

(51) Int. Cl. H04L 12/26

(52) U.S. Cl. CPC H04L 43/0882; H04L 43/04
USPC 709/224

(57) ABSTRACT

A method detects a request higher than the baseline in baseline monitoring and stores the request in an outlier request DB. The method selects a common pattern from requests stored in the outlier request DB, differentiates between a request including the pattern and a request not including the pattern, and monitors them with different baselines as different services.

### BACKGROUND

This invention relates to a service monitoring system and in particular, relates to a service monitoring system for monitoring service performance.

Development of network infrastructures including the Internet and advent of various portable terminals including PCs allow us to easily access information contained in the information network at anytime and anywhere. The information network has become popular because everyone is able to find proper information from an aggregation of a variety of information existing in the real world and provide information far and wide without difficulty through web technology

We access services implemented with web applications of a web system to find or provide information. The web system is connected to the information network and the accessed services are provided by the web system. Since the current web system provides a huge number of services, we can use various services. The use of services is increasing in frequency and scale.

In the meanwhile, service entities for providing services launch new services one after another and renew existing services in a short period. Companies develop services for inside or outside the companies and use the developed services to expedite and facilitate their business.

In such drastic changes in use conditions of users like us and services provided by service providers such as service entities or companies, the services are required to ensure user comfort all the time. Hence, demanded is a service monitoring system for monitoring service performance of the web system from the view point of end users in addition to monitoring the loads to the servers included in the web system. The service performance means the performance of the web system in providing services.

Desired for the service monitoring system is installation at low cost and service performance monitoring with accuracy. Furthermore, it is desired that the service monitoring system can determine existence of any problem and create a solution to the problem from the result of monitoring by the service monitoring system.

Traditional monitoring systems determine a threshold for each monitoring parameter that can be monitored in the monitoring target servers and compares monitoring results with the threshold to detect an anomaly. However, determining an appropriate threshold to each monitoring parameter is difficult and takes considerable man-hours.

For these reasons, a monitoring system has been proposed that creates a model representing temporal variation of the load to a system based on past load information, compares the current load information with threshold data at the time corresponding to the time of acquisition of the load information to detect an anomalous load (for example, Patent Literature 1).

The threshold data as disclosed in Patent Literature 1 is called a baseline. The monitoring system in Patent Literature 1 compares the current load information with the baseline according to the past records to determine whether the current load is a usual one or an unusual one and determine normal or abnormal in accordance with the determination.

In the meanwhile, a technique has been proposed that extracts time-series data indicating the performance of a monitoring target system at a specific cycle and if the extracted time-series data meets some criteria defined with a variation pattern or feature data indicating a specific numerical value, stores the extracted time-series data in a storage device as past metadata (for example, refer to Patent Literature 2).

The technique disclosed in Patent Literature 2 estimates a trend of future variation based on the past time-series data if a result of comparison of the time-series data of a real-time monitoring result with the past metadata satisfies a predetermined criterion for a match.

Another technique has been proposed that, when asynchronous communications, like in Ajax, are generated from an access-permitted page using a web access log, determines the similarity of the URL of the page that generates asynchronous communications to a URL requested by a user in the past with reference to the web access log (for example, Patent Literature 3).

The technique disclosed in Patent Literature 3 A skips an access permission determination logic if the result of the determination indicates that the URLs are similar. As a result, the technique disclosed in Patent Literature 3 solves a problem of a delay in displaying a web page.

For the service performance monitoring, real-time monitoring is demanded because end users have severe requirements on the service performance. To achieve the real-time monitoring, stream data processing has been proposed (for example, Patent Literature 4). The stream data processing system according to Patent Literature 4 processes momentarily arriving stream data in real time.

Patent Literature 1: JP 2001-142746 A

Patent Literature 2: JP 2009-289221 A

Patent Literature 3: JP 2008-204425 A

Patent Literature 4: JP 2006-338432 A

### SUMMARY

In baseline monitoring, a traditional monitoring system determines whether the monitoring target system is normal or abnormal by comparing measured loads with the normal variation in load (baseline). The monitoring system disclosed in Patent Literature 1 performs baseline monitoring with a baseline or a model of normal temporal variation in load to the monitoring target system.

To perform baseline monitoring on service responsivity to accesses from users to a monitoring target service, the monitoring system regards the responsivity in the time slot showing a close number of accesses to the monitoring target service in the past as the baseline because the accesses from users to the monitoring target system are not uniform all the time.

In monitoring the service responsivity, the monitoring system uses a part of uniform resource identifier (URI) to identify a monitoring target service. A URI includes a plurality of character strings.

The monitoring system regards requests designating URIs including some common character string as requests to the same web service. The monitoring system measures the response times to the requests regarded as the requests to the same web service. The monitoring system then extracts the measured response times determined to be a predetermined time or shorter and defines a baseline with the average value of the extracted response times.

The reason why the monitoring system regards the requests designating URIs including a common character string as the requests to the same service is as follows. If the services are identified with the entire URIs, the monitoring system distinguishes all accessible files since it distinguishes access destination path information included in the URIs. However, all the accessible files are huge in quantity, so that the monitoring target services are huge in quantity as well, increasing the load to the monitoring system.

In addition, if the monitoring system identifies far to the query information included in the requests, few or no complete matches can be found between the current URI and the past URIs. Accordingly, the monitoring system cannot find the same service between in the past and at the present, being unable to define a baseline.

All the user requests regarded as the same service do not have the identical access path information or substance of request. Because of the difference in lower directory name or query information in the access path information, the response times to the requests become different. The monitoring system compares the response times to the requests with the response times to past requests having common parts in the URIs; as the response times to the requests range widely, requests anomalously deviating from the baseline increase. As a result, there has arisen a problem that anomaly alerts are issued too frequently.

Furthermore, since real-time operation is demanded for the web system, the monitoring system needs to monitor appropriate monitoring target services all the time and immediately make an anomaly alert when an anomaly occurs.

This invention aims, as described above, to provide a service monitoring system for accurately monitoring service performance by monitoring the service performance with an appropriate baseline.

A representative example of this invention is a service monitoring system including: a terminal for sending requests for services; a monitoring target system for sending responses in accordance with the requests sent from the terminal; a traffic monitoring server installed between the terminal and the monitoring target systems; and a service monitoring server connected with the traffic monitoring server, wherein the traffic monitoring server and the service monitoring server each include a processor and a memory, wherein the traffic monitoring server receives requests sent from the terminal and responses sent from the monitoring target system, wherein the traffic monitoring server acquires identifiers of services requested for and corresponding service performance values indicating performance of the monitoring target system providing the services based on the received requests and responses, wherein the service monitoring server includes a monitoring target service storage unit including a first character string and a value identifying a first group assigned to the first character string, wherein the service monitoring server receives the identifiers of services and the corresponding service performance values acquired by the traffic monitoring server, wherein, in a case where a received identifier of a service includes the first character string, the service monitoring server classifies the received corresponding service performance value as a first group based on the monitoring target service storage unit, wherein the service monitoring server defines a baseline for the first group based on service performance values classified as the first group, wherein in a case where the service monitoring server receives an identifier and a service performance value of a first service, the identifier of the first service includes the first character string, and the service performance value of the first service is higher than predetermined criteria based on the baseline for the first group, the service monitoring server stores the identifier and the service performance value of the first service to an outlier storage unit, wherein in a case where the service monitoring server receives an identifier and a service performance value of a second service, the identifier of the second service includes the first character string, and the service performance value of the second service is higher than the predetermined criteria based on the baseline for the first group, the service monitoring server determines whether the identifier of the first service includes a second character string other than the first character string included in the identifier of the second service based on the outlier storage unit, and wherein, in a case where a result of the determination indicates that the identifier of the first service includes the second character string, the service monitoring server outputs a third character string including the first character string and the second character string as a proposed character string to be assigned a new group.

An embodiment of this invention achieves monitoring of service performance with accuracy.

### BRIEF DESCRIPTION OF THE DRAWINGS

FIG. 1 is a block diagram illustrating a configuration of a service monitoring system in Embodiment 1;

FIG. 2 is a block diagram illustrating a physical configuration of each computer included in the service monitoring system in Embodiment 1;

FIG. 3 is a block diagram illustrating a physical configuration and a logical configuration of a service monitoring server in Embodiment 1;

FIG. 4A is an explanatory diagram illustrating an outline of processing of the service monitoring system in Embodiment 1 before baseline optimization;

FIG. 4B is an explanatory diagram illustrating a screen image showing a baseline before baseline optimization in Embodiment 1;

FIG. 5A is an explanatory diagram illustrating an outline of processing of the service monitoring system in Embodiment 1 after baseline optimization;

FIG. 5B is an explanatory diagram illustrating a screen image showing baselines after baseline optimization in Embodiment 1;

FIG. 6 is an explanatory diagram illustrating a service setting screen displayed by the service monitoring server in Embodiment 1;

FIG. 7A is an explanatory diagram illustrating a configuration and a processing flow of a traffic monitoring agent in Embodiment 1;

FIG. 7B is an explanatory diagram illustrating an input stream input to the traffic monitoring agent in Embodiment 1;

FIG. 8 is an explanatory diagram illustrating a monitored information stream sent from the traffic monitoring agent in Embodiment 1;

FIG. 9 is an explanatory diagram illustrating a processing flow of a service monitoring manager in Embodiment 1;

FIG. 10A is an explanatory diagram illustrating an output stream and an outlier request table in Embodiment 1;

FIG. 10B is an explanatory diagram illustrating an output stream and an event table in Embodiment 1;

FIG. 11A is an explanatory diagram illustrating an output stream and a service performance table in Embodiment 1;

FIG. 11B is an explanatory diagram illustrating an output stream and a baseline table in Embodiment 1;

FIG. 12 is a flowchart illustrating processing of a performance analyzer in Embodiment 1;

FIG. 13 is a flowchart illustrating details of event notification in Embodiment 1;

FIG. 14 is an explanatory diagram illustrating a monitoring screen before baseline optimization by the service monitoring system in Embodiment 1;

FIG. 15 is an explanatory diagram illustrating a service setting screen displayed to define a new baseline in Embodiment 1;

FIG. 16 is an explanatory diagram illustrating a monitoring screen after baseline optimization by the service monitoring system in Embodiment 1; and

FIG. 17 is a block diagram illustrating a service monitoring system in Embodiment 2 in the case where a web system is implemented with a virtual server.

### DETAILED DESCRIPTION OF THE EMBODIMENTS

This invention acquires requests sent from users and determines an appropriate baseline based on information of the acquired stream data and URIs included in past requests in storage.

### Embodiment 1

An optimum embodiment of this invention is described with drawings.

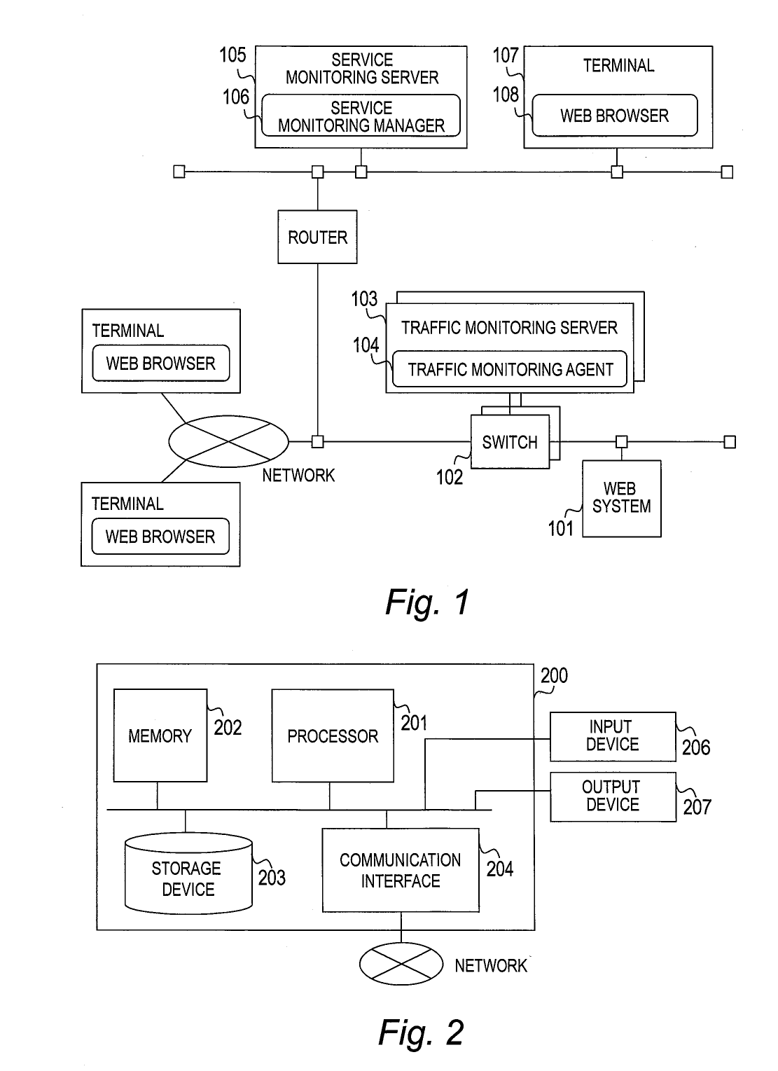

FIG. 1 is a block diagram illustrating a configuration of a service monitoring system in Embodiment 1.

The service monitoring system in Embodiment 1 includes apparatuses of a web system 101, at least one switch 102, at least one traffic monitoring server 103, a service monitoring server 105, and at least one terminal 107. The apparatuses included in the service monitoring system are connected via network apparatuses such as switches or routers and via a network such as the Internet as necessary.

The web system 101 is a computer system for providing web services to users. The web system 101 may include a plurality of computers. Upon receipt of a packet including a request from a terminal 107, the web system 101 sends a packet including a response to the request to the terminal 107.

The terminal 107 is an apparatus for a user to input a request to the web system 101. The terminal 107 includes a processor and a memory, and runs a web browser 108 with the processor. The web browser 108 is a program for allowing the user to input a request and displaying a response of the web system 101 to the request.

The terminal 107 sends a packet including a request of a user to the web system 101 through the web browser 108.

The switch 102 includes a mirror port of a port for forwarding packets sent from the terminal 107 to the web system 101 and a mirror port of a port for forwarding packets sent from the web system 101 to the terminal 107. The switch 102 mirrors packets sent from the web system 101 and packets to be received by the web system 101 with these mirror ports, and sends the mirrored packets to the traffic monitoring server 103. In this description, the operation that the switch 102 mirrors a packet is referred to as capturing a packet.

The traffic monitoring server 103 is connected with the switch 102. The traffic monitoring server 103 is an apparatus for determining the traffic condition in the web system 101 based on the packets sent by the web system 101 and the packets received by the web system 101. The traffic monitoring server 103 has a traffic monitoring agent 104.

Upon receipt of a bunch of packets (HTTP packets in this embodiment) from the switch 102, the traffic monitoring agent 104 in the traffic monitoring server 103 acquires the contents of the mirrored packets. It analyzes the acquired contents and, from the analysis results, calculates a response time of the web system 101 to each request as a performance value of a service. Further, the traffic monitoring server 103 sends each calculated response time together with specifics of acquired packets to the service monitoring server 105.

If the service monitoring system in this embodiment includes a plurality of traffic monitoring servers 103, each of the traffic monitoring servers 103 may collect and analyze packets mirrored by a switch 102 connected with the traffic monitoring server 103.

The apparatus for determining the traffic condition in the web system 101 is not limited to the traffic monitoring server 103 and may be any apparatus as far as it has functions to collect and analyze packets transmitted in the network, calculate response times from the analysis results, and send the specifics of the packets and the response times to the service monitoring server 105.

The service monitoring server 105 is an apparatus for determining a URI appropriate to define a baseline from URIs included in packets. The service monitoring server 105 has a service monitoring manager 106. The service monitoring manager 106 is a program to implement functions of the service monitoring server 105.

Upon receipt of response times with specifics of packets from the traffic monitoring server 103, the service monitoring manager 106 compares, based on the specifics of packets and response time, each response time with a predefined baseline by monitoring target service. The service monitoring manager 106 then determines whether the response time is anomalous or not based on the result of comparison.

The service monitoring manager 106 also defines a baseline based on predetermined conditions to level response times. Further, the service monitoring manager 106 stores the requests to which the response times are deviated from the baseline and identifies a common character string from the URIs of the stored requests. The service monitoring manager 106 defines a baseline for the requests including the common URI and a baseline for the requests not including the common URI, and monitors the service performance with the two defined baselines.

FIG. 2 is a block diagram illustrating a physical configuration of each computer 200 included in the service monitoring system in Embodiment 1.

The computers included in the service monitoring system, such as the traffic monitoring server 103, the service monitoring server 105, and terminals 107, have the same physical configuration as the computer 200 illustrated in FIG. 2. Each computer included in the service monitoring system includes at least a processor 201, a memory 202, a storage device 203, and a communication interface 204. Each computer to be operated by a user further includes an input device 206 and an output device 207.

The processor 201, the memory 202, the storage device 203, the communication interface 204, the input device 206, and the output device 207 are connected by a bus.

The storage device 203 is a device for storing data; data and programs are stored therein. The processor 201 loads the data and programs stored in the storage device 203 into the memory 202 and runs the programs using the memory 202. As a result, each computer implements functions.

The communication interface 204 is a device to send and receive packets between the computer and other computers. The input device 206 is a device for a user to input data to the computer 200. The output device 207 is a device to output data, such as a display or a printer.

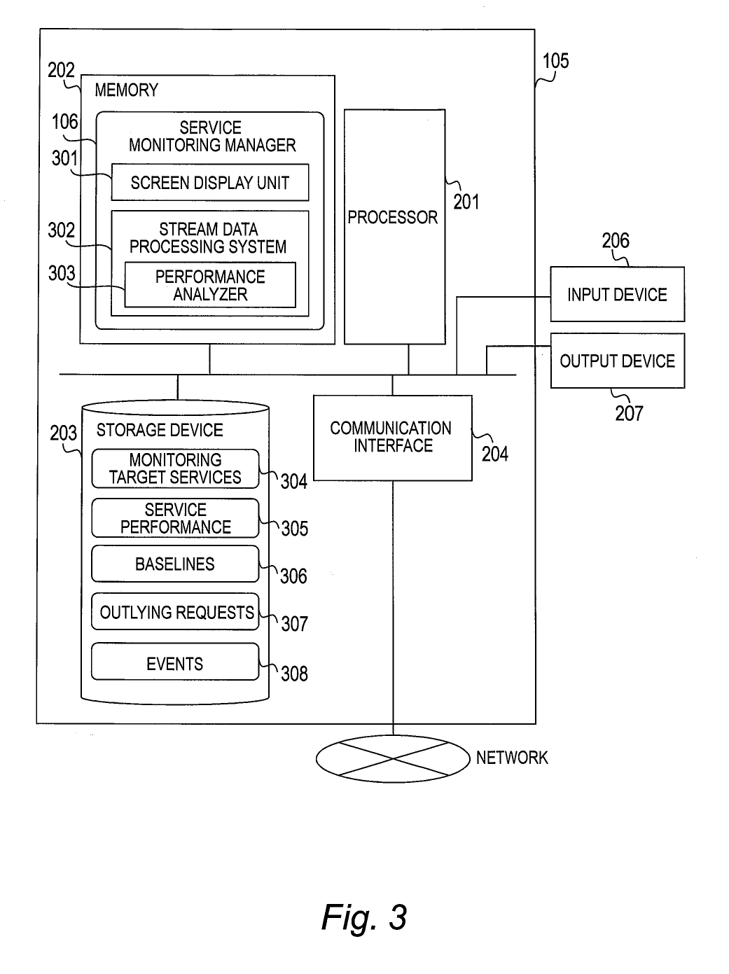

FIG. 3 is a block diagram illustrating a physical configuration and a logical configuration of the service monitoring server 105 in Embodiment 1.

The storage device 203 of the service monitoring server 105 includes data such as a monitoring target service table 304, a service performance table 305, a baseline table 306, an outlying request table 307, and an event table 308. To the memory 202 of the service monitoring server 105, a service monitoring manager 106 is loaded.

The service monitoring manager 106 includes a screen display unit 301 and a stream data processing system 302. The stream data processing system 302 includes a performance analyzer 303. In this embodiment, the service monitoring manager 106 is implemented with a program; however, the service monitoring server 106 may implement the functions of the program with a processing device such as an LSI.

The monitoring target service table 304, the service performance table 305, the baseline table 306, the outlying request table 307, and the event table 308 are storage areas for retaining data in table formats; however, the data may be retained in any format as far as the service monitoring manager 106 can identify the stored data.

The service monitoring server 105 sends a processing result of the service monitoring manager 106 to a terminal 107 and receives an instruction of a user from the terminal 107 through the web browser 108 in the terminal 107 and the communication interface 204 in the service monitoring server 105. It also receives the specifics of packets and response times sent from the traffic monitoring server 103 through the communication interface 204.

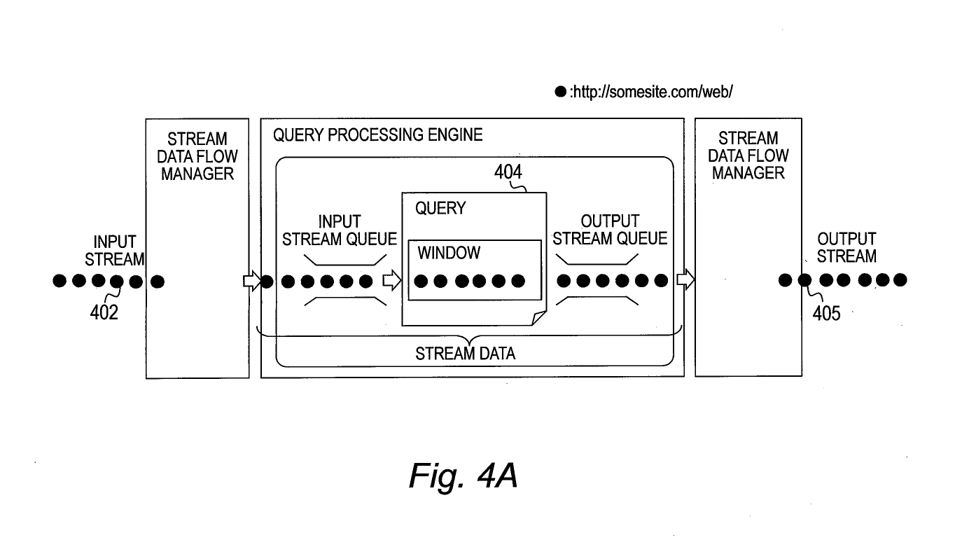

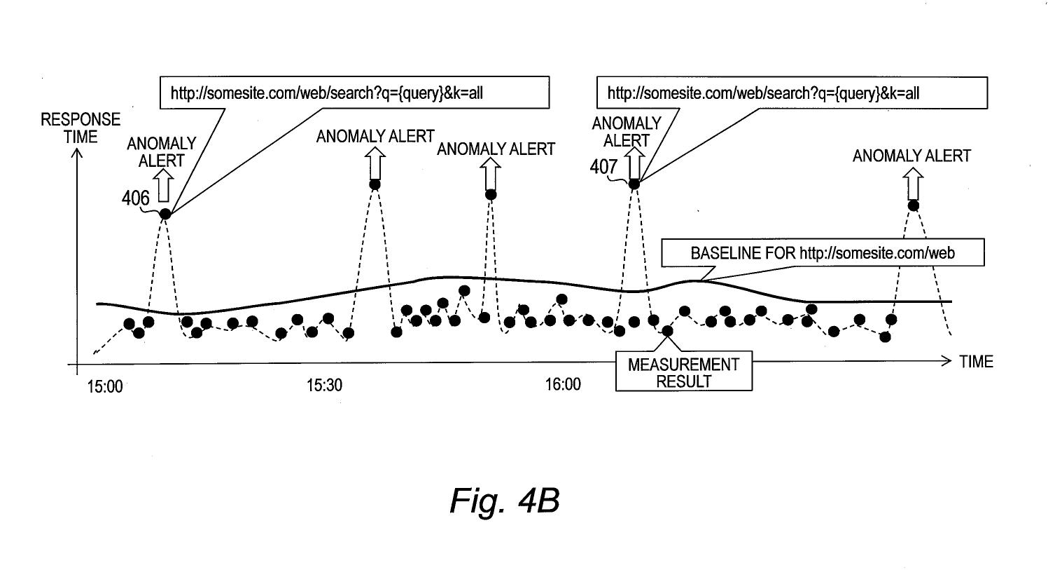

FIG. 4A is an explanatory diagram illustrating an outline of processing of the service monitoring system in Embodiment 1 before baseline optimization.

FIG. 4A illustrates a general idea of processing stream data by the service monitoring system in this embodiment before optimizing a baseline for a monitoring target service.

FIG. 4A is an explanatory diagram illustrating a general idea of processing stream data by each of the traffic monitoring server 103 and the service monitoring server 105. The traffic monitoring server 103 and the service monitoring server 105 each have a stream data flow manager and a query processing engine to process received stream data in real time.

The stream data flow manager and the query processing engine are run on the memory by the processor of the traffic monitoring server 103 or the service monitoring server 105.

The stream data flow manager can receive packets transmitted in the network in real time. The stream data flow manager can also output stream data processed by the query processing engine serially.

An input stream 402 is stream data received by the stream data flow manager. An output stream 405 is stream data output from the stream data flow manager.

The query processing engine stores the input stream 402 to an input stream queue. The query processing engine has a query 404. The query 404 is a process predefined by a developer or others and is retained in the memory in advance.

The query 404, for example, acquires the input stream 402 received every predetermined length of time (window) from the packets stored in the input stream queue. The query 404 performs predetermined processing on the acquired input stream 402 during the window to generate an output stream 405.

The generated output stream 405 is stored in an output stream queue. The stream data flow manager acquires the output stream 405 from the output stream queue and outputs the acquired output stream 405.

The input stream 402 shown in FIG. 4A is a plurality of streams each including a character string of “HTTP://somesite.com/web/” in the URI. The query 404 in FIG. 4A regards the entire input stream 402 as packets about the requests to the same monitoring target service. Accordingly, the query in FIG. 4A creates only one baseline from the input stream 402.

The output stream 405 shown in FIG. 4A includes only one baseline for the monitoring target service including a character string of “HTTP://somesite.com/web/” in the URIs.

FIG. 4B is an explanatory diagram illustrating a screen image showing a baseline before baseline optimization in Embodiment 1.

FIG. 4B illustrates an example of a screen image showing a baseline defined by the query 404 in FIG. 4A and the results of measurement based on the input stream 402. The horizontal axis of the graph in FIG. 4B represents time and the vertical axis represents response time. In FIG. 4B, the query 404 in this embodiment measures a response time after sending a request for the service until receiving a response on each request to monitor the service performance. The filled circles in FIG. 4B represent measured response times included in the input stream 402.

The response time represented by the filled circle 406 and the response time represented by the filled circle 407 shown in FIG. 4B are values deviated far from the baseline for “HTTP://somesite.com/web/”. Accordingly, the query 404 outputs anomaly alerts about the filled circle 406 and the filled circle 407.

The URI of the service resulting in the response time of the filled circle 406 is “http://somesite.com/web/search?q={query}&k=all”, which is the same as the URI of the service resulting in the response time of the filled circle 407. If the service provided with the URI including “http://somesite.com/web/search?q={query}&k=all” is provided in the response time of the filled circle 406 or the filled circle 407 every time, the query 404 may not need to output anomaly alerts about the filled circles 406 and 407.

The service monitoring system in this embodiment optimizes the baseline and adds a new baseline to reduce the foregoing unnecessary anomaly alerts.

The service monitoring system in this embodiment shows information such as a URI and a response time upon a user's click on a filled circle when the image example in FIG. 4B is displayed on the output display device 207 of the service monitoring server 105.

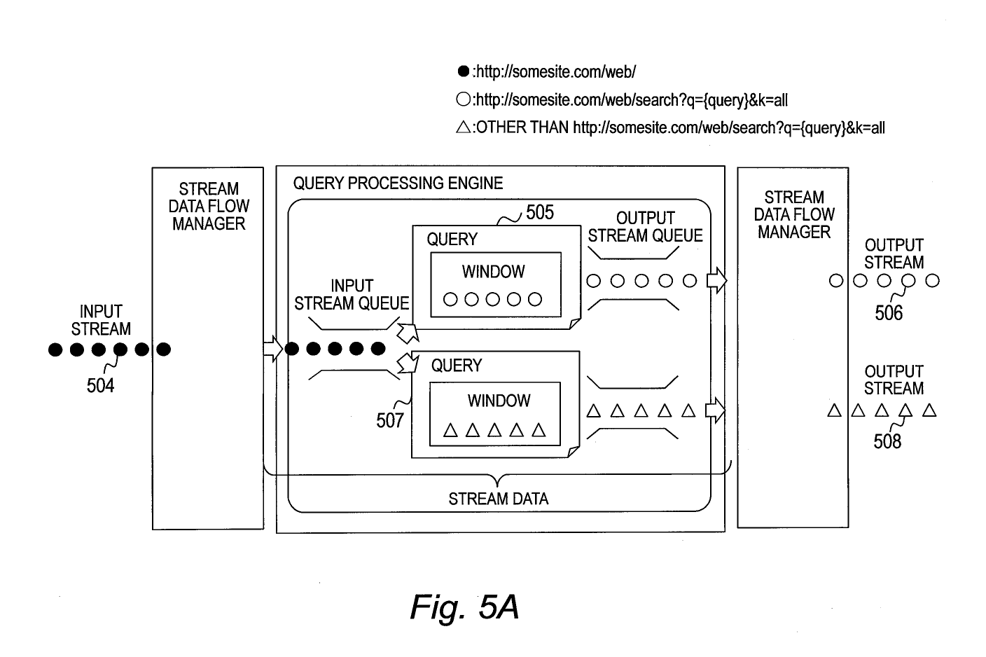

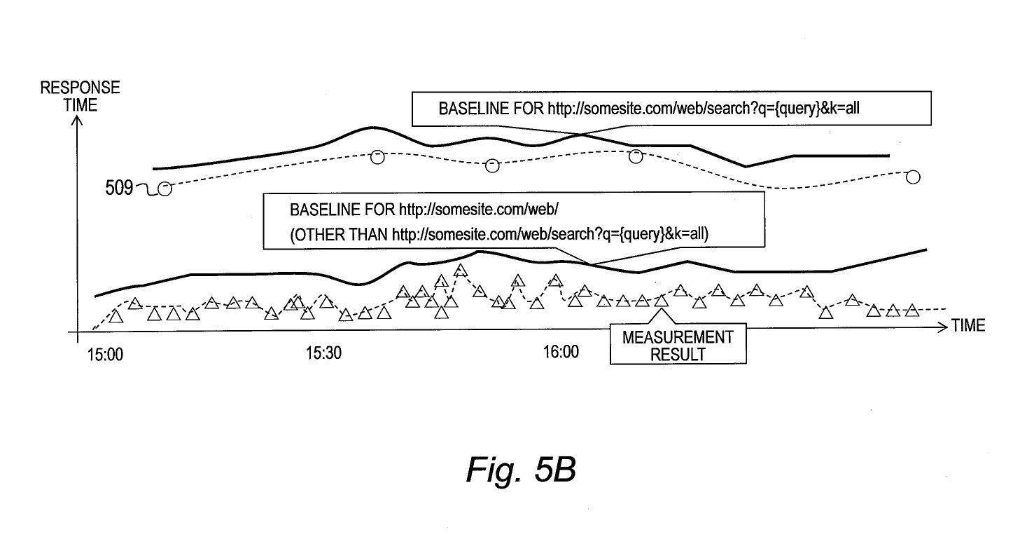

FIG. 5A is an explanatory diagram illustrating an outline of processing of the service monitoring system in Embodiment 1 after baseline optimization.

The input stream 504 in FIG. 5A is the same as the input stream 402 in FIG. 4A. However, the query processing engine in FIG. 5A is different from the query processing engine in FIG. 4A in the point that the query processing engine in FIG. 5A has a query 505 and a query 507. In this embodiment, the processing on the stream data illustrated in FIG. 5A is performed by the service monitoring server 105.

The processing performed by the query 505 includes acquiring an input stream including a character string of “http://somesite.com/web/search?q={query}&k=all” in URIs from the input stream queue by a predetermined size of window. The processing performed by the query 505 further includes defining a baseline for “http://somesite.com/web/search?q={query}&k=all” based on the acquired input stream.

The processing performed by the query 507 includes acquiring an input stream including a character string of “http://somesite.com/web/” in URIs but not including a character string of “http://somesite.com/web/search?q={query}&k=all” in URIs from the input stream queue by a predetermined size of window. The processing performed by the query 507 further includes defining a baseline for “http://somesite.com/web/” based on the acquired input stream.

The output stream 506 includes a baseline for the service including the character string of “http://somesite.com/web/search?q={query}&k=all” in URIs. The output stream 508 includes a baseline for the service including a character string of “http://somesite.com/web/” in URIs but not including the character string of “http://somesite.com/web/search?q={query}&k=all” in the URIs.

FIG. 5B is an explanatory diagram illustrating a screen image showing baselines after baseline optimization in Embodiment 1.

FIG. 5B illustrates an example of a screen image showing a baseline defined by the queries 505 and 507 shown in FIG. 5A and measurement results on the input stream 504. Like in FIG. 4B, the horizontal axis of the graph in FIG. 5B represents time and the vertical axis represents response time. The open circles represent response times in the input stream measured by the query 505. The triangles represent response times of packets measured by the query 507.

The open circles 509 in FIG. 5B are the same as the filled circles 406 in FIG. 4B. However, since the measurement results included in the input stream about “http://somesite.com/web/search?q={query}&k=all” are monitored with the baseline defined by the query 505, no anomaly alert like in FIG. 4B is issued.

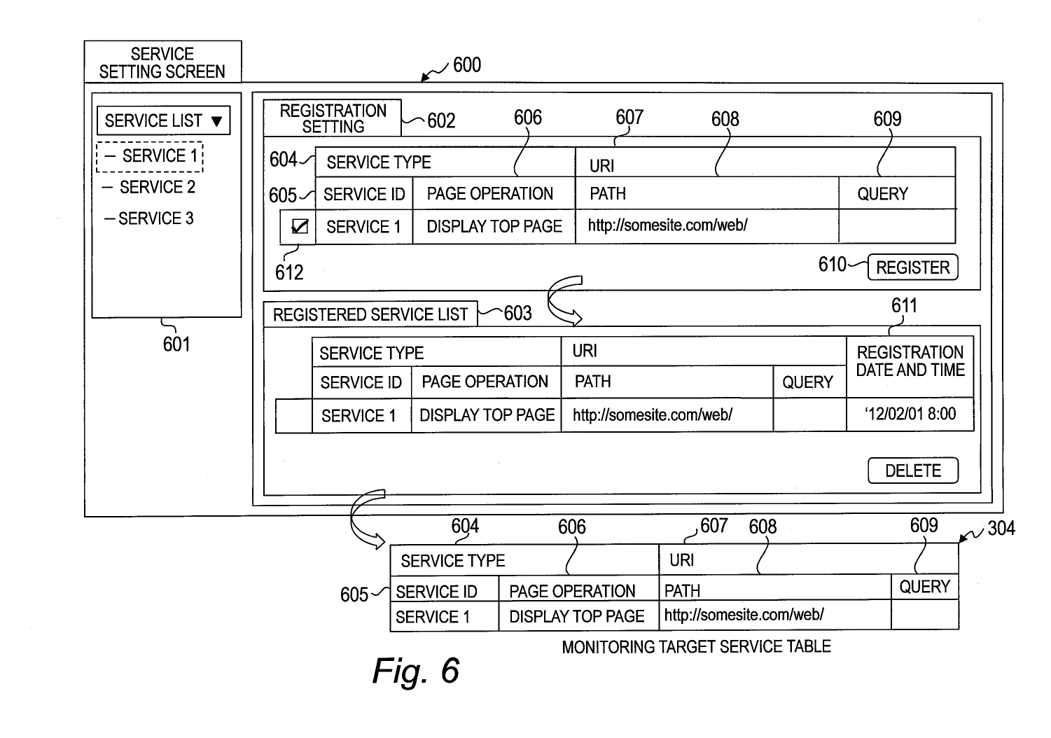

FIG. 6 is an explanatory diagram of a service setting screen 600 displayed by the service monitoring server 105 in Embodiment 1.

The service setting screen 600 illustrated in FIG. 6 is an example of a screen displayed on the output device 207 of the service monitoring server 105 by the screen display unit 301 of the service monitoring manager 106 installed in the service monitoring server 105. The screen display unit 301 displays a service setting screen 600 on the output device 207 in accordance with an instruction of the user.

For the service monitoring system of this embodiment to monitor the performance of the web system 101 providing services, a user such as a developer or a system administrator inputs information on the monitoring target services and baselines for the monitoring target services to the service monitoring server 105 through the service setting screen 600.

The service setting screen 600 includes a service list 601, a registration setting section 602, and a registered service list 603. The service list 601 shows a list of monitoring target services.

The registration setting section 602 is a section to enter information on a baseline for a monitoring target service selected by the user from the service list 601. Furthermore, the registration setting section 602 is a section for the user to newly add at least either a monitoring target service or a baseline for a monitoring target service.

The registration setting section 602 includes a service type 604, a URI 607, a checkbox 612, and a REGISTER button 610.

The values included in the service type 604 are unique to the URI for which a baseline is to be defined. The service type 604 includes a service ID 605 and a page operation 606.

The service ID 605 indicates the identifier of a monitoring target service; the page operation 606 indicates what kind of operation the service designated by the URI 607 provides in the monitoring target service identified by the service ID 605. The page operation 606 in FIG. 6 indicates “DISPLAY TOP PAGE”; accordingly, the URI path specified by the URI 607 is a path to display the top page of the monitoring target service.

The URI 607 includes a path 608 and a query 609. The path 608 indicates the URI path for which a baseline is created in the monitoring target service identified by the service ID 605. The query 609 indicates a URI query for which a baseline is created in the monitoring target service identified by the service ID 605.

The checkbox 612 and the REGISTER button 610 are sections for the user to register the information entered in the registration setting section 602 into the registered service list 603 and the monitoring target service table 304.

The registered service list 603 is a section to show the information entered in the registration setting section 602. For example, when the user clicks the REGISTER button 610 after checking the checkbox, the screen display unit 301 displays information entered in the registration setting section 602 and the time of click on the REGISTER button (registration date and time 611) in the registered service list 603.

Furthermore, the screen display unit 301 stores the information entered in the registration setting section 602 in the monitoring target service table 304 when the user clicks the REGISTER button 610. The monitoring target service table 304 is a table including information on the monitoring target services and containing the same information entered to the registration setting section 602.

Accordingly, the monitoring target service table 304 includes service types 604 and URIs 607, like the registration setting section 602. Each entry of the monitoring target service table 304 indicates a character string of at least a part of a URI for which a baseline is to be defined. Each entry of the monitoring target service table 304 indicates a group of URIs for which a baseline is to be defined.

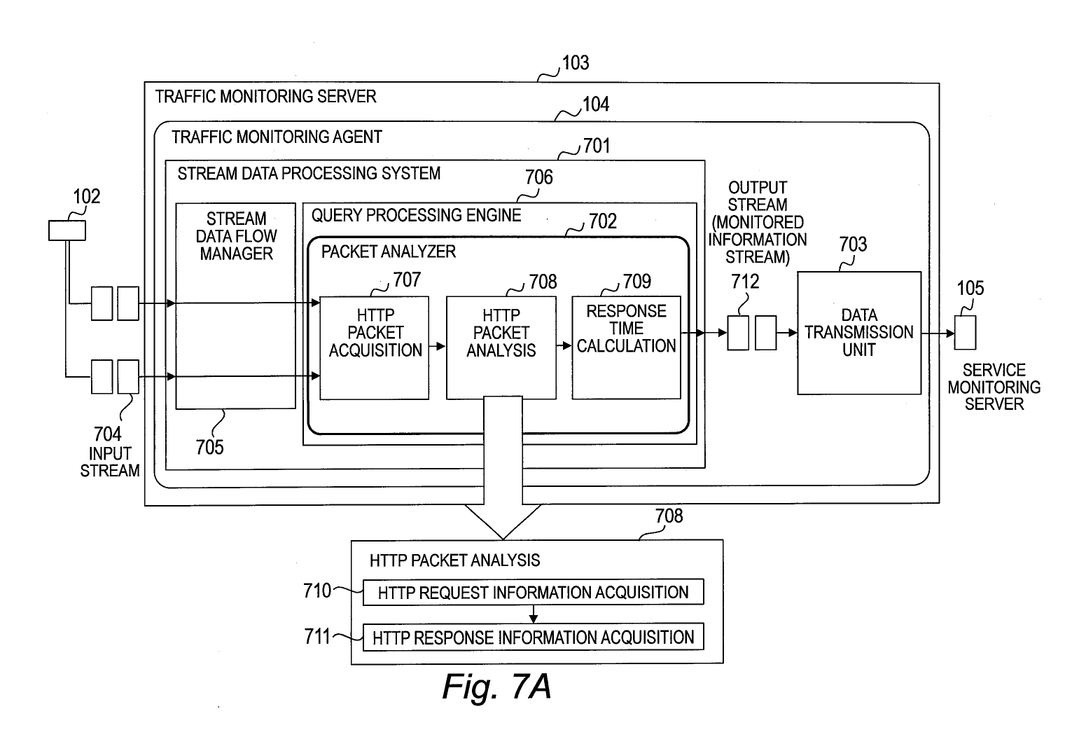

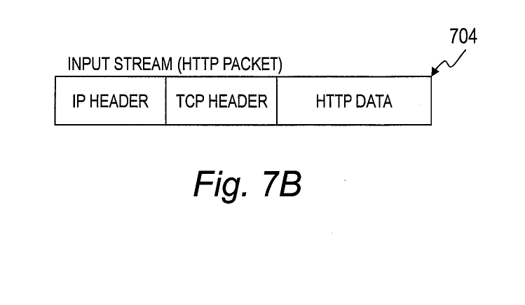

FIG. 7A is an explanatory diagram illustrating a configuration and a processing flow of the traffic monitoring agent 104 in Embodiment 1.

The traffic monitoring agent 104 includes a stream data processing system 701 and a data transmission unit 703. The stream data processing system 701 includes a stream data flow manager 705 and a query processing engine 706.

The query processing engine 706 corresponds to the query processing engine shown in FIG. 4A. The query processing engine 706 has, in advance, a packet analyzer 702 as the query 404.

The method for the stream data processing system 701 to retain stream data, the method for the stream data processing system 701 to analyze a query input by the user, and to register, after analysis, an optimized or created query 404 in the query processing engine 706 may employ the techniques disclosed in Patent Literature 4.

The stream data processing system 701 receives at least one HTTP packet (an input stream 704) from the switch 102 via the communication interface 204 of the traffic monitoring server 103. The switch 102 sends captured HTTP packets to the traffic monitoring server 103 as stream data.

The stream data flow manager 705 transfers the received input stream 704 to the query processing engine 706. The query processing engine 706 instructs the packet analyzer 702 to process the received input stream 704.

The packet analyzer 702 includes HTTP packet acquisition 707, HTTP packet analysis 708, and response time calculation 709. The packet analyzer 702 executes the HTTP packet acquisition 707, the HTTP packet analysis 708, and the response time calculation 709 in this order.

The packet analyzer 702 acquires IP header information or HTTP header information from the header of each HTTP packet at the HTTP packet acquisition 707. The packet analyzer 702 also acquires the time of receipt of the HTTP packet at the traffic monitoring server 103.

It should be noted that the packet analyzer 702 may execute the subsequent processing in this embodiment, or the HTTP packet analysis 708, using either the IP header information or both of the IP header information and the HTTP header information; however, the following description provides an example that executes the HTTP packet analysis 708 using only the HTTP header.

The HTTP packet analysis 708 includes HTTP request information acquisition 710 and HTTP response information acquisition 711.

The packet analyzer 702 determines, in the HTTP request information acquisition 710, whether the received input stream 704 is an HTTP request from the HTTP header acquired in the HTTP packet acquisition 707. If the received input stream 704 is determined to be an HTTP request, the packet analyzer 702 retains the input stream 704 of an HTTP request.

Subsequently, the packet analyzer 702 determines, in the HTTP response information acquisition 711, whether each input stream 704 received later than the input stream 704 determined to be an HTTP request is an HTTP response to the retained HTTP request.

If the HTTP header of a received input stream 704 indicates an HTTP response and includes the same URI included in the HTTP header of the retained HTTP request, the packet analyzer 702 determines that the received input stream 704 is the HTTP response to the retained HTTP request. The packet analyzer 702 extracts the retained HTTP request and the HTTP response to the retained HTTP request.

It should be noted that an HTTP request is an HTTP packet including a request sent from a terminal 107 and an HTTP response is an HTTP packet sent by the web system 101 to the terminal 107 in order to respond to a request from the terminal 107.

After the HTTP packet analysis 708, the packet analyzer 702 calculates a response time (response time calculation 709) from the HTTP request and the HTTP response extracted in the HTTP packet analysis 708. The response time is the difference between the time of receipt of the HTTP request at the traffic monitoring server 103 and the time of receipt of the HTTP response at the traffic monitoring server 103.

After the response time calculation 709, the packet analyzer 702 outputs an output stream including a part of the HTTP header of the HTTP request, a part of the HTTP header of the HTTP response, and the calculated response time. The data transmission unit 703 sends the output stream output from the packet analyzer 702 as a monitored information stream 712 to the service monitoring server 105.

FIG. 7B is an explanatory diagram illustrating an input stream 704 input to the traffic monitoring agent 104 in Embodiment 1.

Each HTTP header in the input stream 704 includes an IP header, a TCP header, and HTTP data. The HTTP data includes an HTTP header indicating whether the HTTP packet is an HTTP request or an HTTP response.

The stream data processing system 701 in the traffic monitoring agent 104 calculates each response time between an HTTP request for a service and an HTTP response thereto and serially sends the calculated response times to the service monitoring server 105.

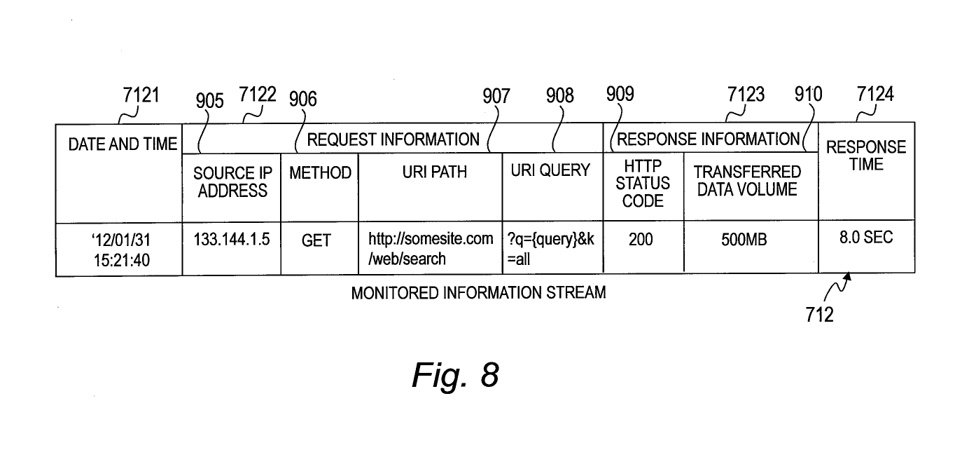

FIG. 8 is an explanatory diagram illustrating a monitored information stream 712 sent from the traffic monitoring agent 104 in Embodiment 1.

The monitored information stream 712 includes a date and time 7121, request information 7122, response information 7123, and a response time 7124. An entry of the monitored information stream 712 indicates information on an HTTP request for a service and an HTTP response to the HTTP request. The date and time 7121 includes a date and time of receipt of an HTTP response at the traffic monitoring server 103.

The request information 7122 includes part of the HTTP header information in the HTTP request. The request information 7122 includes a source IP address 905, a method 906, a URI path 907, and a URI query 908.

The source IP address 905 indicates the IP address of the terminal 107 that has requested a service. The method 906 indicates the substance of the instruction from the terminal 107 to the service. The URI path 907 is an address to send the request for the service, indicating the address of the file in the web system 101 to provide the service requested by the terminal 107. The URI query 908 indicates the query for the web system 101 to provide the service.

The response information 7123 includes part of the HTTP header information in the HTTP response. The response information 7123 includes an HTTP status code 909 and a transferred data volume 910.

The HTTP status code 909 indicates a value to provide the service to the terminal 107. The HTTP status code 909 includes a value indicating whether the service can be provided normally to the terminal 107. The transferred data volume 910 indicates the amount of data to be sent from the web system 101 to the terminal 107 to provide the service.

The response time 7124 indicates the response time calculated in the response time calculation 709. In this embodiment, the value indicated in the response time 7124 is a result of measurement of service performance provided by the service monitoring system in this embodiment, indicating a performance value of the service.

The time indicated in the response time 7124 is a time between receipt of an HTTP request and receipt of an HTTP response to the request at the traffic monitoring server 103. That is to say, the time indicated in the response time 7124 corresponds to the time after the web system 101 receives the HTTP request until the web system 101 sends the HTTP response.

The way to calculate the response time is not limited to the foregoing one. That is to say, the response time may be calculated based on the times of receipt of packets at the switch 102 or the times of acquisition of packets at a computer included in the web system 101.

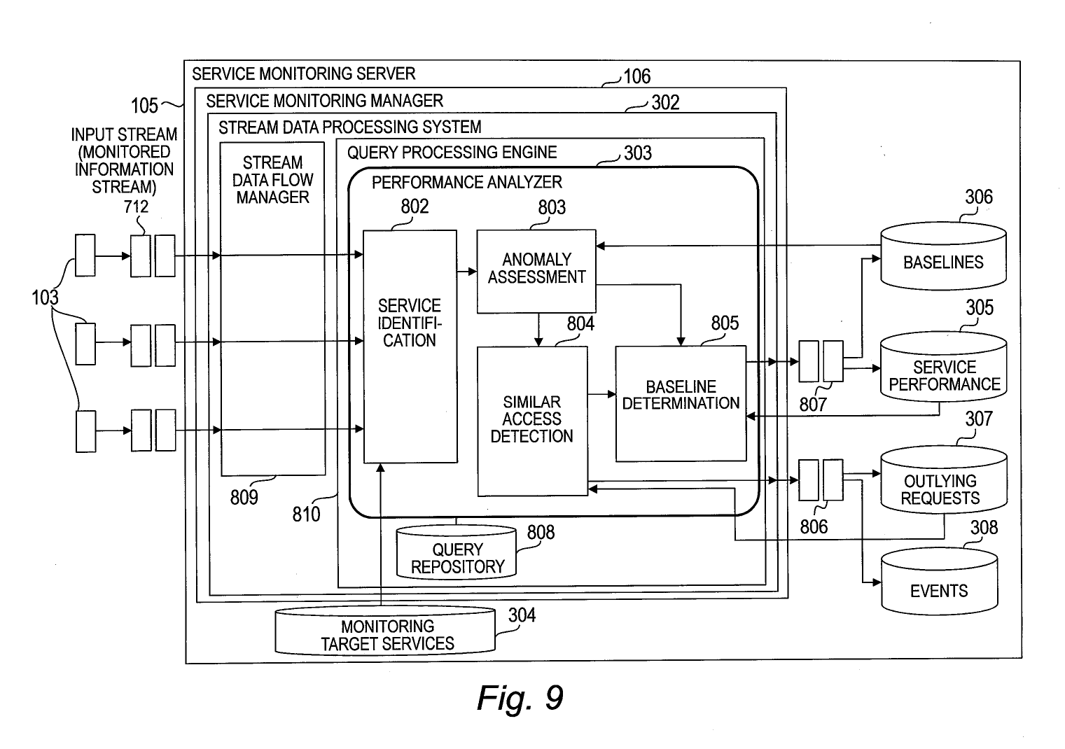

FIG. 9 is an explanatory diagram illustrating an outline of a processing flow of the service monitoring manager 106 in Embodiment 1.

The service monitoring manager 106 in the service monitoring server 105 has a stream data processing system 302. The stream data processing system 302 includes a stream data flow manager 809 and a query processing engine 810.

The query processing engine 810 in the stream data processing system 302 runs a performance analyzer 303 included in the stream data processing system 302. The performance analyzer 303 corresponds to the query 404 shown in FIG. 4A or the query 505 and the query 507 shown in FIG. 5A.

The performance analyzer 303 is connected to the query repository 808. The query repository 808 stores executable codes for the processing of the performance analyzer 303.

It should be noted that the processing flow in FIG. 9 illustrates an outline; accordingly, FIG. 9 does not include processing of the screen display unit 301 and other units.

Monitored information streams 712 are sent from traffic monitoring servers 103 to the service monitoring server 105. The monitored information streams 712 are transferred by the stream data flow manager 809 in the stream data processing system 302 to the query processing engine 810 as an input stream for the service monitoring manager 106.

When the query processing engine 810 receives a monitored information stream 712, the performance analyzer 303 executes service identification 802, anomaly assessment 803, similar access detection 804, and baseline determination 805 on each received monitored information stream 712.

In the service identification 802, the performance analyzer 303 identifies values of the service type 604 associated with the received monitored information stream 712 based on the monitoring target service table 304. After the service identification 802, the performance analyzer 303 executes anomaly assessment 803 based on the tuple of monitored information stream 712 and the baseline table 306.

After the anomaly assessment 803, the performance analyzer 303 executes similar access detection 804. In the similar access determination 804, the performance analyzer 303 creates an output stream 806 including a proposed URI for which a new baseline is to be defined based on the monitored information stream 712 assessed as anomalous and the outlying request table 307. The performance analyzer 303 stores the output stream 806 in the outlying request table 307 and the event table 308.

After the similar access detection 804 or the anomaly assessment 803, the performance analyzer 303 executes baseline determination 805. The performance analyzer 303 statistically processes the measurement results in the monitored information stream 712 stored within a predetermined time period (for example, one minute) by service type. The performance analyzer 303 creates an output stream 807 including statistics of the results of statistic processing and stores the created output stream 807 to the service performance table 305.

In the baseline determination 805, the performance analyzer 303 further calculates total numbers of processing (throughput) by service type using the monitored information stream 712 stored in a predetermined period (for example, one hour). The performance analyzer 303 defines a baseline based on the calculated throughput, the service performance table 305, and the later-described conditions. The performance analyzer 303 includes the defined baseline in the output stream 807 and stores the output stream 807 in the baseline table 306.

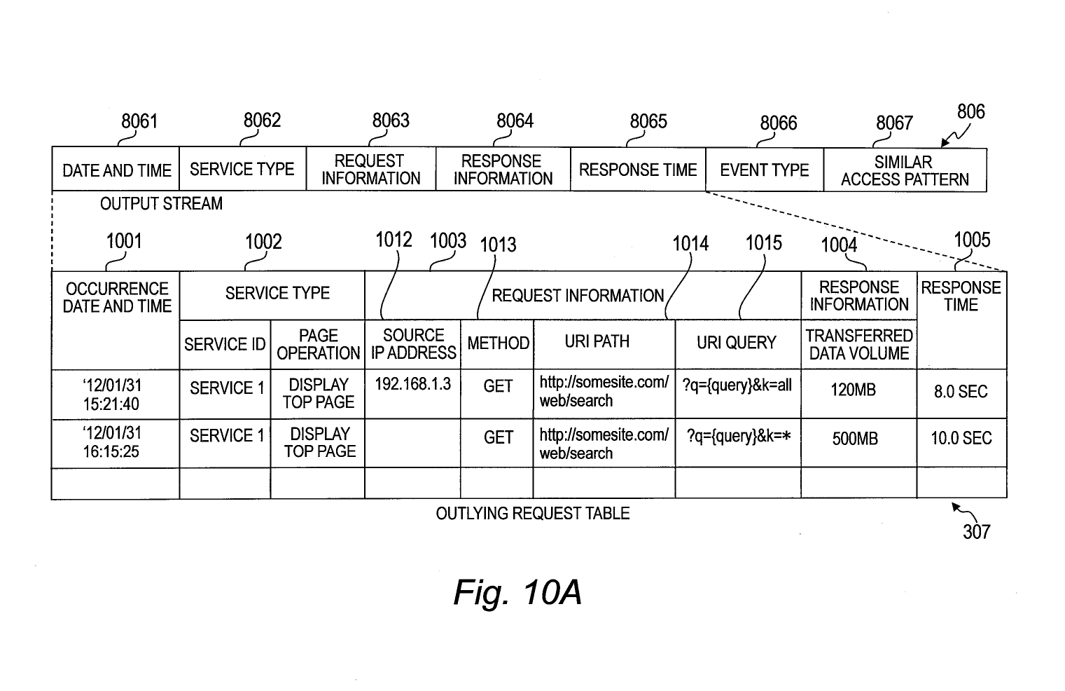

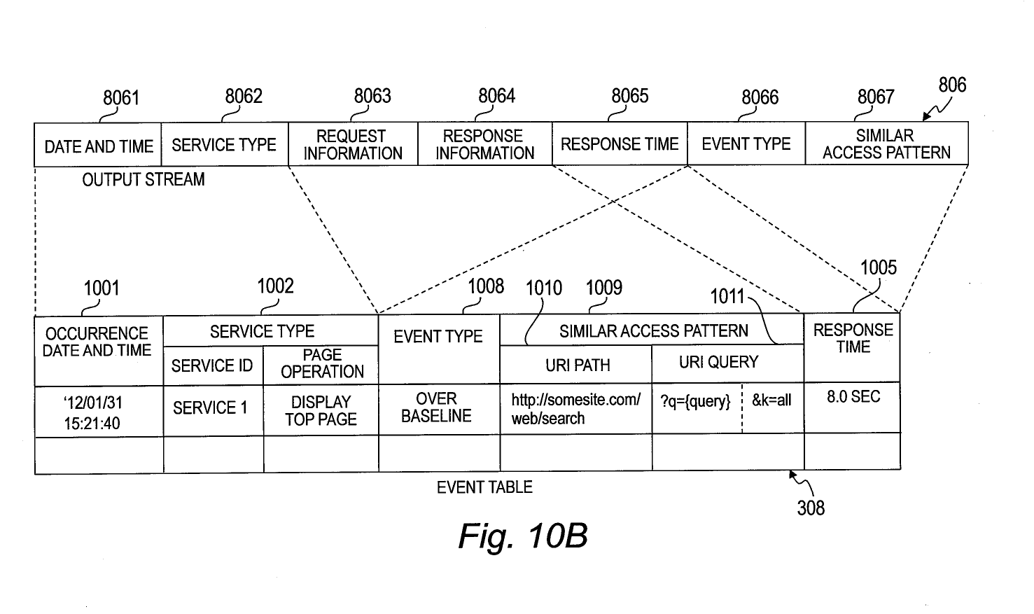

FIG. 10A is an explanatory diagram illustrating an output stream 806 and an outlying request table 307 in Embodiment 1.

The outlying request table 307 is a table for the service monitoring server 105 to retain the monitored information streams 712 assessed as anomalous in the anomaly assessment 803.

The outlying request table 307 includes occurrence dates and times 1001, service types 1002, request information 1003, response information 1004, and response times 1005. An occurrence date and time 1001 corresponds to a date and time 7121 in the monitored information stream 712.

A service type 1002 indicates the service type of a monitored information stream 712 identified by the service identification 802. The service type 1002 includes a service ID 1006 and a page operation 1007. The service ID 1006 and the page operation 1007 correspond to a service ID 605 and a page operation 606, respectively, in the monitoring target service table 304.

Request information 1003 corresponds to request information 7122 in the monitored information stream 712. Accordingly, the source IP address 1012, the method 1013, the URI path 1014, and the URI query 1015 included in the request information 1003 correspond to a source IP address 905, a method 906, a URI path 907, and a URI query 908 in the monitored information stream 712.

Response information 1004 corresponds to a transferred data volume 910 in the monitored information stream 712. A response time 1005 corresponds to a response time 7124 in the monitored information stream 712.

Each output stream 806 created by the performance analyzer 303 includes a date and time 8061, a service type 8062, request information 8063, response information 8064, a response time 8065, an event type 8066, and a similar access pattern 8067. The performance analyzer 303 includes a monitored information stream 712 and a result of service identification 802 in the output stream 806 to store values in the outlying request table 307.

FIG. 10B is an explanatory diagram illustrating an output stream 806 and an event table 308 in Embodiment 1.

The event table 308 is a table for the service monitoring server 105 to retain proposed URIs for which baselines are to be defined selected from the URIs of the monitored information streams 712 assessed as anomalous in the anomaly assessment 803.

The event table 308 includes occurrence dates and times 1001, service types 1002, event types 1008, similar access patterns 1009, and response times 1005. The occurrence dates and times 1001, service types 1002, and response times 1005 in the event table 308 are common to the occurrence dates and times 1001, service types 1002, and response times 1005 in the outlying request table 307.

An event type 1008 includes a value to inform the user that the result of measurement is over a predefined baseline. A similar access pattern 1009 indicates a proposed URI for which a new baseline is to be defined determined in the baseline determination 805.

The similar access pattern 1009 includes a URI path 1010 and a URI query 1011. The URI path 1010 and the URI query 1011 correspond to a path 608 and a query 609 in the monitoring target service table 304.

The performance analyzer 303 stores the date and time 8061, the service type 8062, the response time 8065, the event type 8066, and the similar access pattern 8067 included in each output stream 806 to the event table 308.

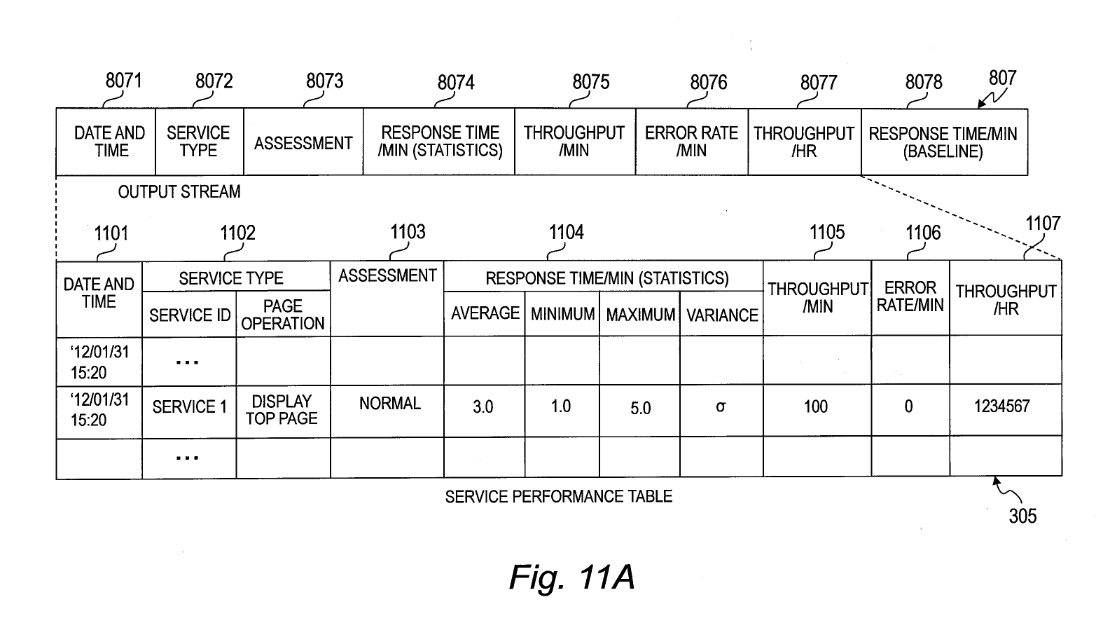

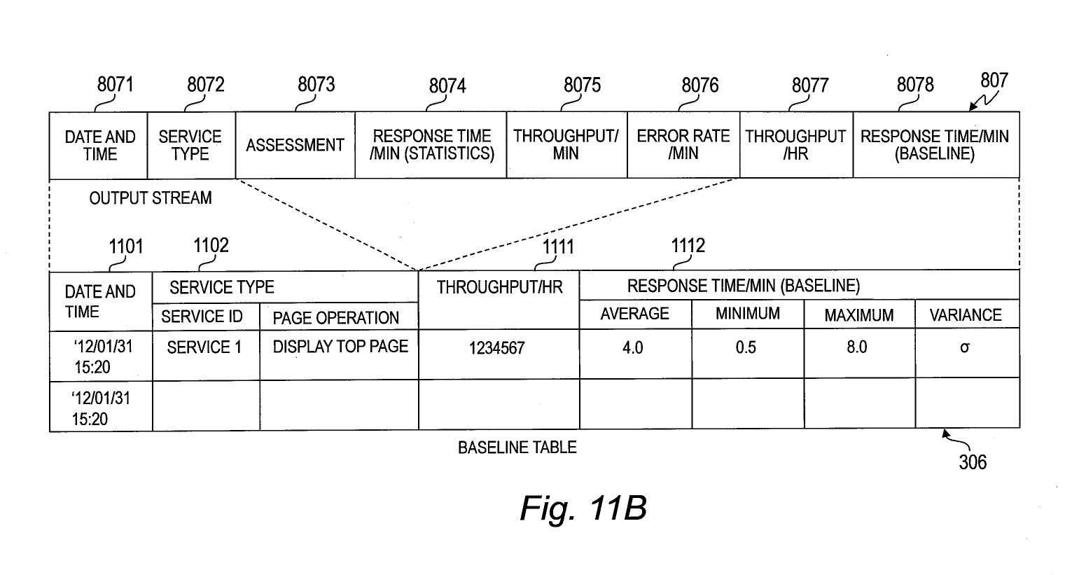

FIG. 11A is an explanatory diagram illustrating an output stream 807 and a service performance table 305 in Embodiment 1.

The service performance table 305 is a table for the service monitoring server 105 to retain the statistics of the measurement results calculated in the baseline determination 805. The service performance table 305 includes dates and times 1101, service types 1102, assessments 1103, response times/min (statistics) 1104, throughputs/min 1105, error rates/min 1106, and throughputs/hour 1107.

A date and time 1101 corresponds to a date and time 7121 in the monitored target stream 712. A service type 1102 includes a service ID and a page operation, corresponding to a service type 604 in the monitoring target service table 304.

An assessment 1103 contains a value indicating a result of assessment in the anomaly assessment 803. A response time/min (statistics) 1104, a throughput/min 1105, and an error rate/min 1106 contain statistics calculated in the baseline determination 805.

A response time/min (statistics) 1104 indicates statistical values of measurement results (response times) for a service type 1102 calculated from the monitored information stream 712 received during a predetermined time (one minute in FIG. 11A) prior to the latest receipt of the monitored information stream 712. Although the response time/min (statistics) 1104 shown in FIG. 11A includes an average, a minimum, a maximum, and a variance, the response time/min (statistics) 1104 in this embodiment may include any statistical values.

A throughput/min 1105 indicates a total number of processing for the service type 1102 calculated from the monitored information stream 712 received during a predetermined time (one minute in FIG. 11A) prior to the latest receipt of the monitored information stream 712.

An error rate/min 1106 indicates an error rate for the service type 1102 calculated from the monitored information stream 712 received during a predetermined time (one minute in FIG. 11A) prior to the latest receipt of the monitored information stream 712.

A throughput/hour 1107 indicates a total number of processing for the service type 1102 calculated from the monitored information stream 712 received during a predetermined time (one hour in FIG. 11A) prior to the latest receipt of the monitored information stream 712.

Each output stream 807 created by the performance analyzer 303 includes a date and time 8071, a service type 8072, an assessment 8073, a response time/min (statistics) 8074, a throughput/min 8075, an error rate/min 8076, a throughput/hour 8077, and a response time/min (baseline) 8078. The performance analyzer 303 stores the date and time 8071, the service type 8072, the assessment 8073, the response time/min (statistics) 8074, the throughput min 8075, the error rate min 8076, and the throughput/hour 8077 included in each output stream 807 to the service performance table 305.

FIG. 11B is an explanatory diagram illustrating an output stream 807 and a baseline table 306 in Embodiment 1.

The baseline table 306 is a table for the service monitoring server 105 to retain the service types for which baselines are defined in the baseline determination 805 and the values of newly defined baselines.

The baseline table 306 includes dates and times 1101, service types 1102, throughputs/hour 1111, and response times/min (baseline) 1112. A date and time 1101 of the baseline table 306 corresponds to a date and time 1101 in the service performance table 305. In addition, a service type 1102 corresponds to a service type 1102 in the service performance table 305.

A throughput/hour 1111 includes statistics calculated in the baseline determination 805. A throughput/hour 1111 indicates a total number of processing about a service type 1102 calculated from the monitored information stream 712 received during a predetermined time (one hour in FIG. 11B) prior to the latest receipt of the monitored information stream 712.

A response time/min (baseline) 1112 indicates values of a baseline defined in the baseline determination 805. The performance analyzer 303 determines the values of the baseline based on calculated throughputs, the service performance table 305, and the later-described conditions, in the baseline determination 805.

The performance analyzer 303 stores the date and time 8071, the service type 8072, the throughput/hour 8077, and the response time/min (baseline) 8078 included in each output stream 807 to the baseline table 306.

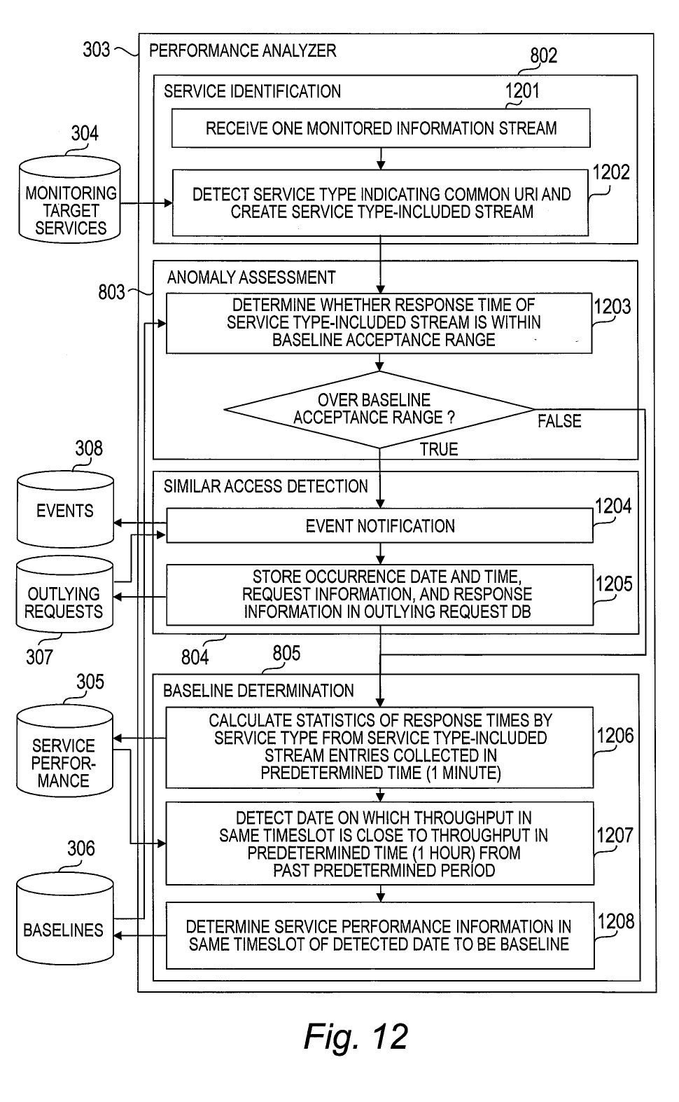

FIG. 12 is a flowchart illustrating processing of the performance analyzer 303 in Embodiment 1.

The processing in FIG. 12 illustrates detailed processing of the performance analyzer 303. The performance analyzer 303 receives one entryinput stream (monitored information stream 712) from the input stream queue in the query processing engine 810 in the service identification 802 (1201).

After Step 1201, the performance analyzer 303 refers to the monitoring target service table 304 to identify an entry including a URI partially the same in character string as the URI (the values of the URI path 907 and the URI query 908) of the received monitored information stream 712 in the URI 607 of the monitoring target service table 304.

Specifically, the performance analyzer 303 compares the URI path 907 with each path 608 to determine whether a part or the entirety of the character string is the same. If the entirety of the URI path 907 is the same as a path 608, the performance analyzer 303 compares the URI query 908 with the query 609 to determine whether a part or the entirety of the character string is the same. Through the foregoing determination, the performance analyzer 303 identifies an entry of the monitoring target service table 304 including, in the URI 607, character strings having the most parts in common with the character strings of the URI path 907 and the URI query 908.

The performance analyzer 303 adds the service type 604 of the identified entry to the received monitored information stream 712 to create a stream with service type (1202). The entry (tuple) for a stream including the service type created at this step is referred to as service type-included stream A.

The foregoing Steps 1201 and 1202 are executed in the service identification 802.

After the service identification 802, the performance analyzer 303 refers to the baseline table 306. The performance analyzer 303 identifies an entry of the baseline table 306 including the value of the service type 604 of the service type-included stream A in the service type 1102 and indicating the latest date and time in the date and time 1101. The performance analyzer 303 acquires the values of the baseline associated with the service type of the service type-included stream A.

The performance analyzer 303 compares the value of the response time 7124 of the service type-included stream A with the values of the response time/min (baseline) 1112 of the identified entry in the baseline table 306. The performance analyzer 303 determines whether the result of comparison indicates that the value of the response time 7124 in the service type-included stream A is included in the baseline acceptance range (1203).

If, for example, the value of the response time 7124 in the service type-included stream A is included between the minimum and the maximum of the response time/min (baseline) 1112 of the identified entry, the performance analyzer 303 may determine that the value of the response time 7124 is included in the baseline acceptance range at Step 1203.

Alternatively, the performance analyzer 303 may calculate a range by adding or subtracting a specific value to or from the average of the response time/min (baseline) 1112 of the identified entry and if the value of the response time 7124 is included in the calculated range, the performance analyzer 303 may determine that the value of the response time 7124 is included in the baseline acceptance range. The performance analyzer 303 may use any determination method as far as the determination at Step 1203 can be made using the values of the response time/min (baseline) 1112.

If the determination at Step 1203 is that the value of the response time 7124 is included in the baseline acceptance range, the performance analyzer 303 executes the baseline determination 805.

If the determination at Step 1203 is that the value of the response time 7124 is not included in the baseline acceptance range and is over the baseline acceptance range, the performance analyzer 303 executes the similar access detection 804.

The foregoing Step 1203 is executed in the anomaly assessment 803.

After the anomaly assessment 803, the performance analyzer 303 refers to the outlying request table 307 in the similar access detection 804. The performance analyzer 303 extracts the URI (the values indicated in the URI path 907 and the URI query 908) of the service type-included stream A being over the baseline acceptance range and determines whether a similar access pattern can be identified using the extracted URI and the outlying request table 307.

The similar access pattern in this embodiment is a URI in which a part or the entirety of the character string is in common with the URI of the service type-included stream A among the URIs in the service type-included stream entries assessed as anomalous in the anomaly assessment 803 in the past. If such a similar access pattern can be identified, the performance analyzer 303 can identify a URI for which a new baseline should be defined because of existence of a service type-included stream assessed as anomalous in the past like the service type-included stream A.

The identifying a similar access pattern in the event notification 1204 will be described later in detail.

If a similar access pattern is identified, the performance analyzer 303 creates an output stream 806 including the date and time 7121 and the service type 604 of the service type-included stream A and a value indicating the identified similar access pattern. The performance analyzer 303 stores a character string of “OVER BASELINE” in the event type 8066 of the output stream 806.

The performance analyzer 303 stores values in a new entry of the event table 308 based on the output stream 806 including the stored values (1204). At Step 1204, the performance analyzer 303 notifies the user of an event indicating the values stored in the event table 308 through the output device 207.

After Step 1204, the performance analyzer 303 stores values included in the service type-included stream A into the output stream 806. The performance analyzer 303 stores values in a new entry of the outlying request table 307 using the output stream 806 including the values in the service type-included stream A (1205). Specifically, the performance analyzer 303 stores values included in the service type-included stream A in the occurrence date and time 1001, the service type 1002, the request information 1003, the response information 1004, and the response time 1005 in the outlying request table 307.

As a result, the performance analyzer 303 can retain a service type-included stream assessed as anomalous in the past. Although values are stored in the output stream 806 in each of the foregoing Steps 1204 and 1205, the output stream 806 including all the values may be created in Step 1205. And at Step 1205, the performance analyzer 303 may further store values to the new entries of the event table 308 and the outlying request table 307.

The foregoing Steps 1204 and 1205 are executed in the similar access detection 804.

After the similar access detection 804 or the anomaly assessment 803, the performance analyzer 303 calculates statistics of the measurement results by service type from past service type-included stream entries received within a predetermined time for Step 1206 and the received latest service type-included stream A (1206). The predetermined time for Step 1206 corresponds to a window illustrated in FIG. 4A or 5A, for example one minute in this embodiment.

At Step 1206, the performance analyzer 303 creates an output stream 807 including the value of the date and time 7121 and the service type included in the service type-included stream A and the calculated statistics. The performance analyzer 303 also stores the value of the date and time 7121, the service type, and the calculated statistics to a new entry of the service performance table 305 using the created output stream 807.

The statistics in this embodiment includes an average, a maximum, a minimum, and a variance of the response time per minute. The statistics in this embodiment also includes a throughput per minute and an error rate per minute. The statistics in this embodiment may include any value as far as it quantitatively indicates variation in response time.

After Step 1206, the performance analyzer 303 calculates a throughput per predetermined time by service type from the past service type-included stream entries received within a predetermined time for Step 1207 and the received latest service type-included stream A (1207). The predetermined time for Step 1207 corresponds to a window shown in FIG. 4A or 5A, for example one hour in this embodiment.

The performance analyzer 303 further identifies entries of the service performance table 305 satisfying all of the following requirements at Step 1207.

The first requirement is that the value of the service type 1102 is the same as the value of the service type in the service type-included stream A.

The second requirement is that the date and time 1101 of the service performance table 305 is within a certain time (for example one month) predetermined by the administrator prior to the time of receipt of the latest service type-included stream A and included in the same timeslot (for example, between 15:00 to 16:00) as the time of receipt of the latest service type-included stream A.

The third requirement is that the value of the throughput/hour 1107 is closest to the value of the throughput per hour calculated with respect to the service type-included stream A.

In the timeslot showing a close request throughput, the load to the web system 101 is likely to be the same level so that the response time from the web system 101 can be the same. Accordingly, the response time in the timeslot showing a close throughput is appropriate for the baseline; the performance analyzer 303 in this embodiment defines a baseline in accordance with the foregoing requirements.

In this embodiment, the user does not need to prepare a baseline since the performance analyzer 303 defines a baseline using the above-described method.

After Step 1207, the performance analyzer 303 determines the values of the response time/min (statistics) 1104 of the identified entry in the service performance table 305 to be the values of a new baseline (1208).

At Step 1208, the performance analyzer 303 creates an output stream 807 including the date and time 7121 and the service type of the service type-included stream A, the value of the throughput (throughput per hour in this embodiment) calculated at Step 1207, and the values of the response time/min (statistics) 1104 determined for a baseline. The performance analyzer 303 stores values included in the created output stream 807 in the new entry of the baseline table 306.

At Step 1208, the performance analyzer 303 may include a result of assessment at the anomaly assessment 803 in the output stream 807. As a result, a value of anomaly or normal in accordance with the output stream 807 is stored in the assessment 1103 of the service performance table 305.

After creating the output stream 807 at Step S 1206, the performance analyzer 303 may store values such as a value of the service type and values of the response time/min (statistics) in the output stream 807 at Step 1208. The performance analyzer 303 may subsequently add entries to the service performance table 305 and the baseline table 306 using the output stream 807.

Steps 1207, 1207, and 1208 are performed in the baseline determination 805.

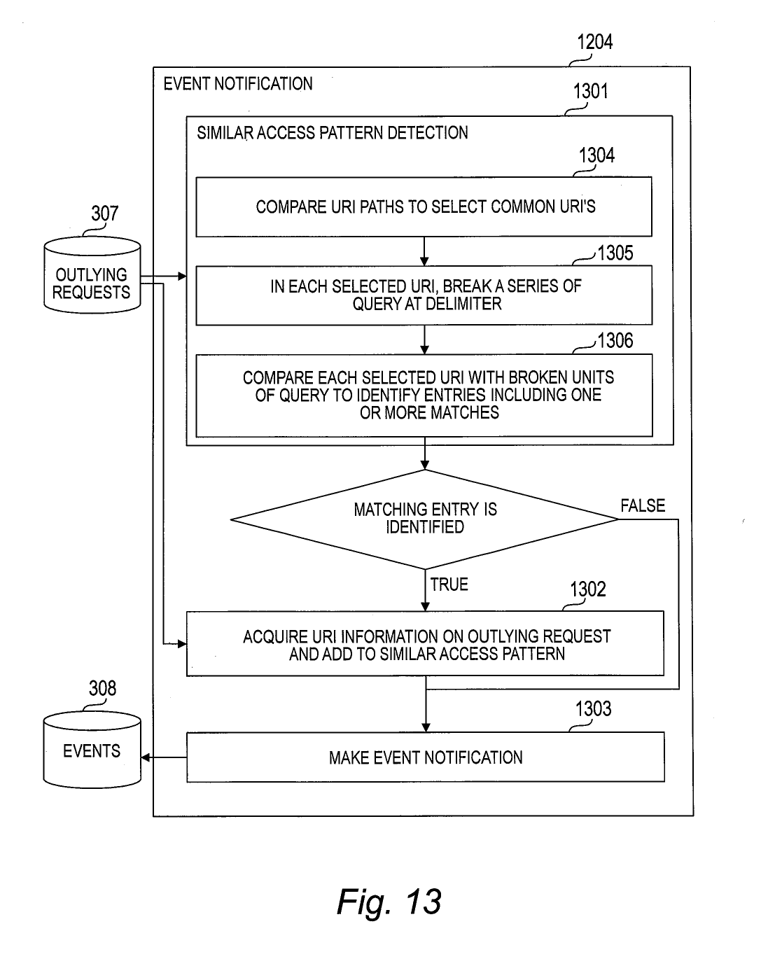

FIG. 13 is a flowchart illustrating details of the event notification 1204 in Embodiment 1.

In the event notification 1204, the performance analyzer 303 executes similar access pattern detection 1301. The similar access pattern detection 1301 identifies service type-included stream entries assessed as anomalous in the past, like the service type-included stream A assessed as anomalous.

In the event notification 1204, the performance analyzer 303 refers to the outlying request table 307. The performance analyzer 303 extracts the value of the URI path 907 of the service type-included stream A being over the baseline acceptance range. The performance analyzer 303 selects all entries of the outlying request table 307 in which the values of the URI paths 1014 are the same character string as the extracted value of the URI path 907 (1304).

If, at Step 1304, no entry is selected from the outlying request table 307, the performance analyzer 303 may terminate the similar access pattern detection 1301.

After Step 1304, the performance analyzer 303 breaks each value of the URI queries 1015 in all of the selected entries at a predetermined delimiter (such as a question mark) to obtain at least one character string including one or more characters (1305). If no value is stored in the URI query 1015 in any of the selected entries, the performance analyzer 303 may terminate the similar access pattern detection 1301.

After Step 1305, the performance analyzer 303 compares the URI query 908 of the service type-included stream A being over the baseline acceptance region with each value of the URI queries 1015 of the entries selected at Step 1304 with respect to each character string obtained by breaking the queries at Step 1305.

Through the comparison, the performance analyzer 303 identifies all the entries of the outlying request table 307 in which at least one of the character strings of the broken query is in common with the value of the URI query 908 in the service type-included stream A (1306).

The foregoing Steps 1304, 1305, and 1306 are executed in the similar access pattern detection 1301. Through the similar access pattern detection 1301 illustrated in FIG. 13, the performance analyzer 303 can identify a similar access pattern in accordance with the URI path and the URI query.

The similar access pattern detection 1301 may use any method as far as a similar access pattern including a URI path and a URI query similar to the URI path 907 and the URI query 908 of the service type-included stream A being over the baseline acceptance range can be acquired; for example, the technique disclosed in JP 2008-204425 A may be used.

The performance analyzer 303 may break an URI path 1014 at a predetermined delimiter (such as a slash) to obtain at least one character string including one or more characters at Step 1305. The performance analyzer 303 may select entries of the outlying request table 307 in which at least one of the broken character strings, which is different from the value of the path 608 in the monitoring target service table 304, is in common with the character string of the URI path 907 in the service type-included stream A. After selection of entries using this method, the performance analyzer 303 may terminate the similar access pattern detection 1301.

The above-described comparison with a broken URI path 1014 enables the performance analyzer 303 to identify a similar access pattern with higher accuracy than in the similar access pattern detection 1301 illustrated in FIG. 13.

After finishing the similar access pattern detection 1301, the performance analyzer 303 determines whether any entry of the outlying request table 307 has been identified in which the URI path 1014 and the URI query 1015 include either the entirety of the URI path 907 and a part of the URI query 908 in the service type-included stream A or the entirety of the URI path 907 in the service type-included stream A. If the determination is that no entry has been identified, the performance analyzer 303 executes Step 1303.

If the determination is that an entry of the outlying request table 307 has been identified through the similar access pattern detection 1301, the performance analyzer 303 identifies the identified entry of the outlying request table 307 as an entry indicating the similar access pattern to the service type-included stream A. If a plurality of entries are identified in the similar access pattern detection 1301, the performance analyzer 303 determines the entry of the outlying request table 307 including the character string of the broken query most matching with the value of the URI query 908 as the entry indicating the similar access pattern (1302).

After Step 1302 or if no entry is identified at the similar access pattern detection 1301, the performance analyzer 303 notifies the output device 207 of an event that the service type-included stream A is over the baseline acceptance range (1303).

At Step 1303, the performance analyzer 303 further stores values representing the service type-included stream A in the event table 308 using an output stream 806. The user can know the necessity of optimization of a baseline with reference to the event the output device 207 is notified of.

After Step 1303, through automatic processing of the screen display unit 301 or a start operation performed by the user, the screen display unit 301 displays a screen for the user to optimize a baseline as necessary to the output device 207. The screen display unit 301 displays a screen for the user to easily change the settings of the baseline in accordance with a result of monitoring service performance.

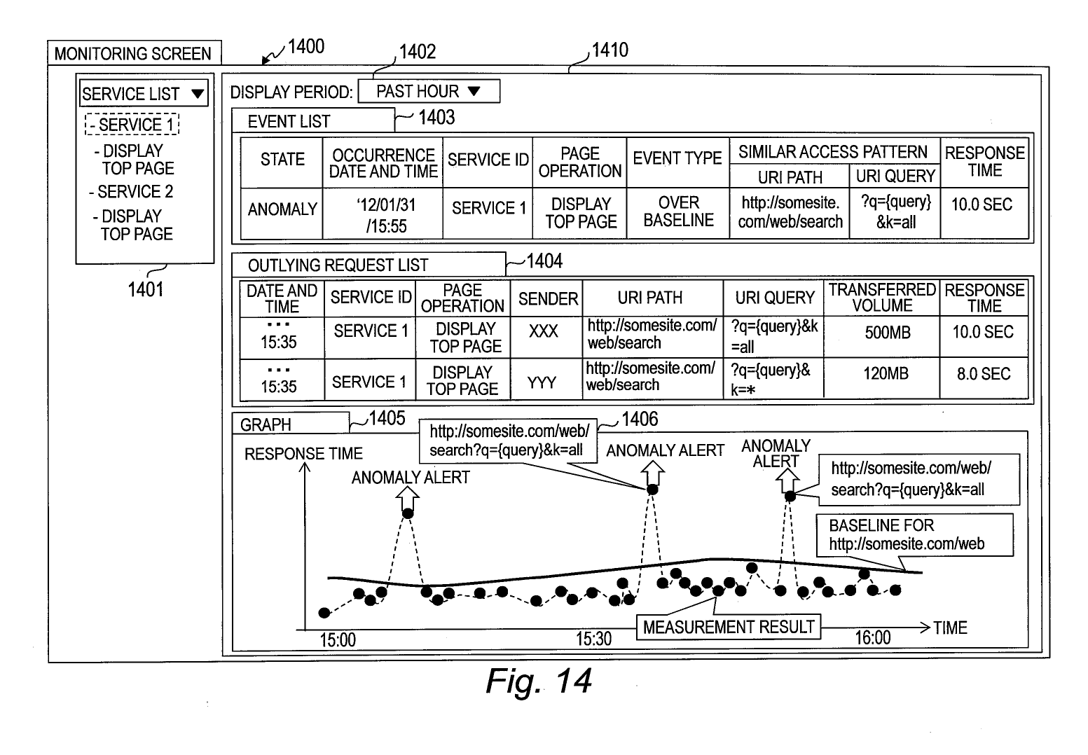

FIGS. 14 to 16 illustrate a monitoring screen and a baseline optimization screen executed by the screen display unit 301 of the service monitoring manager 106 installed in the service monitoring server 105.

FIG. 14 is an explanatory diagram illustrating a monitoring screen 1400 before baseline optimization performed by the service monitoring system in Embodiment 1.

When only one baseline is defined in the baseline table 306, such as at the start of monitoring by the service monitoring system, the screen display unit 301 displays, for example, the monitoring screen 1400 of FIG. 14.

The monitoring screen 1400 includes a service list 1401 and a monitoring result display section 1410. The monitoring result display section 1410 includes a display period designation section 1402, an event list 1403, an outlying request list 1404, and a graphic display section 1405.

The service list 1401 displays a list of the service IDs of monitoring target services. The screen display unit 301 may display the values of page operations 606 in the monitoring target service table 304 to display a determined baseline in the service list 1401. The user selects a monitoring target service about which the user wants to display details of a monitoring result from the monitoring target services indicated in the service list 1401.

The display period designation section 1402 displays a list of periods such as the past hour and the past week. The user specifies the period in the display period designation section 1402 to designate the period in which the monitoring result to be displayed in the monitoring result display section 1410 have been acquired.

The screen display unit 301 acquires the monitoring target service selected by the user in the service list 1401 and acquires the period designated by the user in the display period designation section 1402. The screen display unit 301 selects a monitoring result acquired in the designated period from the result of monitoring the service performance of the selected monitoring target service and displays them in the monitoring result display section 1410.

The event list 1403 displays a list of events that have occurred in monitoring the service performance of the selected monitoring target service during the designated period. Specifically, the screen display unit 301 selects entries of the event table 308 in which the values of the occurrence dates and times 1001 are included in the designated period and the service IDs of the service types 1002 indicate the selected monitoring target service and displays them in the event list 1403.

In displaying the event list 1403 shown in FIG. 14, the screen display unit 301 adds information indicating that the state of the monitoring result indicated in the entry is anomalous to each entry. The user can acquire a URI for a group of services to define a new baseline from the similar access patterns indicated in the event list 1403.

The outlying request list 1404 displays a list of outlying requests that have occurred in the monitoring of the service performance of the selected monitoring target service during the designated period. The screen display unit 301 selects entries of the outlying request table 307 in which the values of the occurrence dates and times 1001 are included in the designated period and the service IDs in the service types 1002 indicate the selected monitoring target service and displays them in the outlying request list 1404. The outlying request list 1404 indicates past monitoring results being over the baseline acceptance range.

The graphic display section 1405 shows results of measurement of response time and a baseline defined for a selected monitoring target service in the result of monitoring the monitoring target service in the designated period. In the graphic display section 1405 shown in FIG. 14, the filled circles represent results of measurement of response time.

The screen display unit 301 extracts entries of the service performance table 305 in which the values of the dates and times 1101 are included in the designated period and the service types 1102 indicate the service ID of the selected monitoring target service. The screen display unit 301 shows any of the averages, the minimums, the maximums, and the variances of the response times min (statistics) 1104 of the extracted entries in the graphic display section 1405 as measurement results.

When the user clicks one of the measurement results deviating from the baseline in the monitoring screen 1400 shown in FIG. 14, the URI 1406 is displayed. The URI 1406 indicates the URI of the monitoring information stream 712 including the response time of the clicked measurement result.

When the event list 1403 shows an event, the user decides whether to define a new baseline based on the event list 1403, the outlying request list 1404, and the graphic display section 1405. To define a new baseline, the user instructs the screen display unit 301 to display a service setting screen 600 with the input device 206.

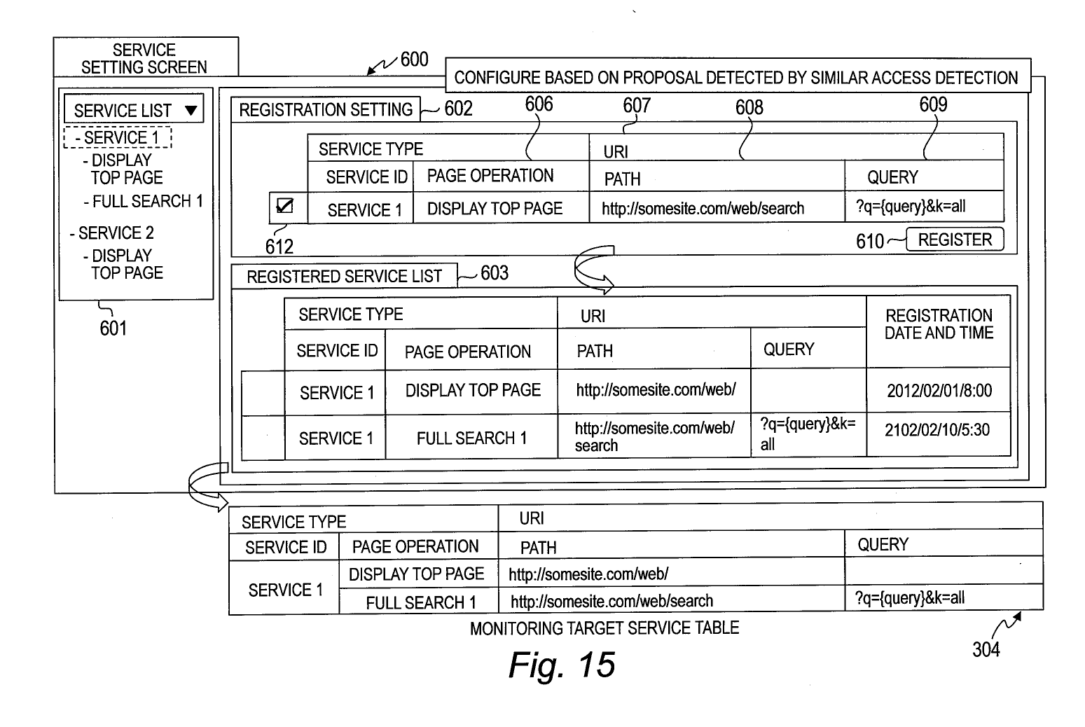

FIG. 15 is an explanatory diagram illustrating a service setting screen 600 to be displayed to define a new baseline in Embodiment 1.

Like the service setting screen 600 shown in FIG. 6, the service setting screen 600 shown in FIG. 15 includes a service list 601, a registration setting section 602, and a registered service list 603.

The user selects the service ID of the monitoring target service for which the user wants to define a new baseline in the service list 601. The user enters a URI representing the group of services for which a new baseline is to be defined in the registration setting section 602 based on the URI path and the URI query of the similar access pattern shown in the event list 1403 in FIG. 14.

At this stage, the user stores an identifier for identifying the group of services for which a new base line is to be defined in the page operation 606 in the registration setting section 602. The page operation 606 in FIG. 15 stores “FULL SEARCH 1”.

The user checks the checkbox 612 of the entry to which the user has entered values in the registration setting section 602 and clicks the REGISTER button 610. Upon click on the REGISTER button 610, the screen display unit 301 acquires the information entered in the registration setting section 602 and displays the acquired information in the registered service list 603. The screen display unit 301 also adds the acquired information to a new entry of the monitoring target service table 304.

As described above, the service monitoring system in this embodiment shows the user a similar access pattern to urge the user to optimize a baseline and, in accordance with selection of the user, adds a URI for which a new baseline is to be defined to the monitoring target service table 304 to optimize a baseline.

A new entry is added to the monitoring target service table 304 through the service setting screen 600 and the processing illustrated in FIG. 12 is performed subsequently, so that an entry representing a newly defined baseline is added to the baseline table 306. Monitoring service performance based on the baseline added to the baseline table 306 achieves appropriate and accurate monitoring of service performance.

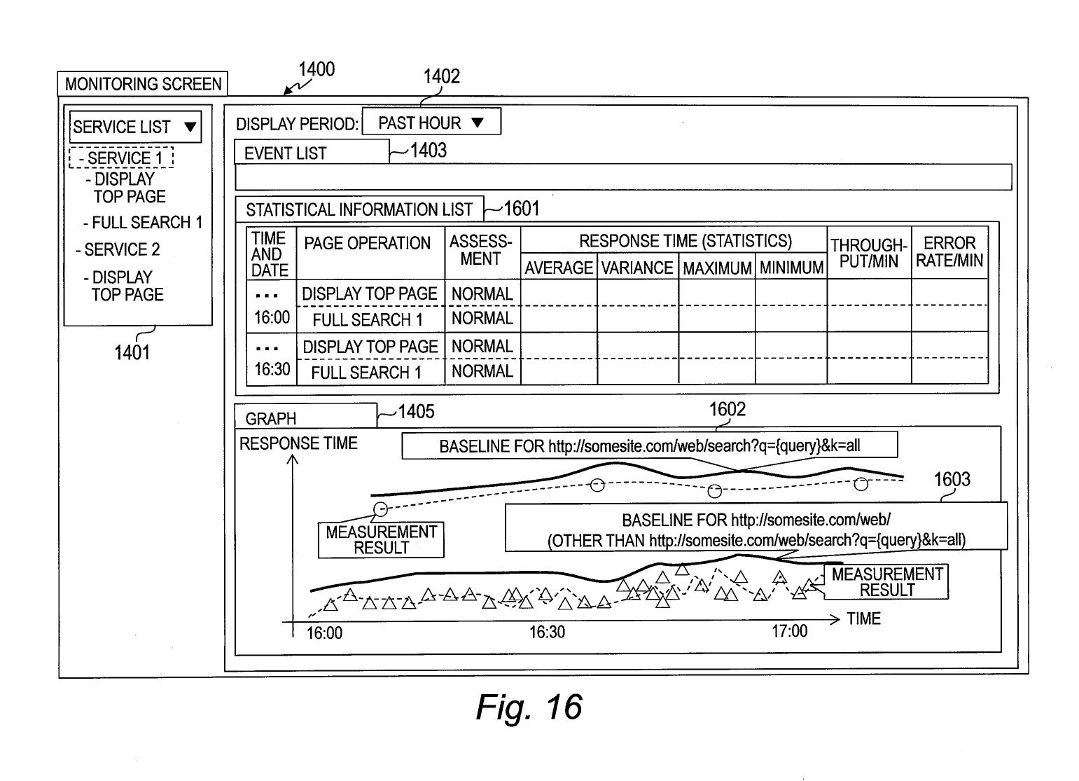

FIG. 16 is an explanatory diagram illustrating a monitoring screen 1400 after baseline optimization in the service monitoring system in Embodiment 1.

The monitoring screen 1400 shown in FIG. 16 is a monitoring screen 1400 called up by the user when the monitoring result is steady and normal. In this condition, the screen display unit 301 does not show anything in the event list 1403. When the event list 1403 does not show any event, the screen display unit 301 displays a statistical information list 1601 instead of the outlying request list 1404.

The statistical information list 1601 indicates statistical information on the result of monitoring the monitoring target service selected in the service list 1401 during the period designated in the display period designation section 1402. Specifically, the screen display unit 301 displays the contents of the entries of the service performance table 305 in which the values of the dates and times 1101 are included in the designated period and the service IDs of the service types 1102 indicate the selected monitoring target service in the statistical information list 1601.

The screen display unit 301 displays results of measurement of response time and baselines for the monitoring target service selected in the service list 1401 during the period designated in the display period designation section 1402 in the graphic display section 1405. If the user clicks the two baselines displayed in the graphic display section 1405, the screen display unit 301 displays the URI 1602 and the URI 1603.

The URI 1602 indicates the URI newly added in FIG. 15. The URI 1603 indicates the URI added in FIG. 6. The information displayed in the graphic display section 1405 includes information in the monitoring service table 304 and the service performance table 305.

Since the baseline has been optimized in the monitoring result shown in FIG. 16, the measurement results alerted as anomalies in the monitoring result shown in FIG. 14 are not alerted as anomalies in the monitoring result shown in FIG. 16. Accordingly, the user can acquire a proper monitoring result.

In the foregoing embodiment, the service monitoring server 105 presents a similar access pattern in the event table 308 for the user to decide whether to add a baseline. As a result, the service monitoring server 105 in this embodiment can properly define appropriate baselines.

However, the performance analyzer 303 may, after the processing illustrated in FIG. 12, automatically determine the similar access pattern to be the URI for a new baseline without presenting the similar access pattern in the event table 308 to the user. The performance analyzer 303 may store the similar access pattern in the monitoring target service table 304. These operations can reduce the workload of the user.

In the foregoing embodiment, the user watches the screens through the output device 207 of the service monitoring server 105. However, the screen display unit 301 may display the screens on the web browser 108 of a terminal 107 the user can watch; it may display the screens on any apparatus as far as it is connected with the service monitoring server 105 in this embodiment. As a result, the user can watch a monitoring result and other information from an apparatus other than the service monitoring server 105.

According to Embodiment 1, if a part of the URI included in the request assessed as anomalous is in common with the URI included in the request assessed as anomalous in the past in monitoring the service performance, the service monitoring system outputs the common part of the URI as a proposed URI for which a new baseline is to be defined. As a result, the service monitoring system in Embodiment 1 can define more appropriate baselines, achieving accurate service performance monitoring.

Furthermore, the service monitoring system in Embodiment 1 allows the user to select the proposed URI for a new baseline on the display, achieving proper determination in defining appropriate baselines.

The traffic monitoring server 103 and the service monitoring server 105 in Embodiment 1 receive stream data including packets captured by the switches 102 to process the received stream data with a query; accordingly, they can process the requests and responses captured by the switches immediately. As a result, the service monitoring system in Embodiment 1 can speedily provide the user with a result of monitoring and a proposed URI for which a new baseline is to be defined.

### Embodiment 2

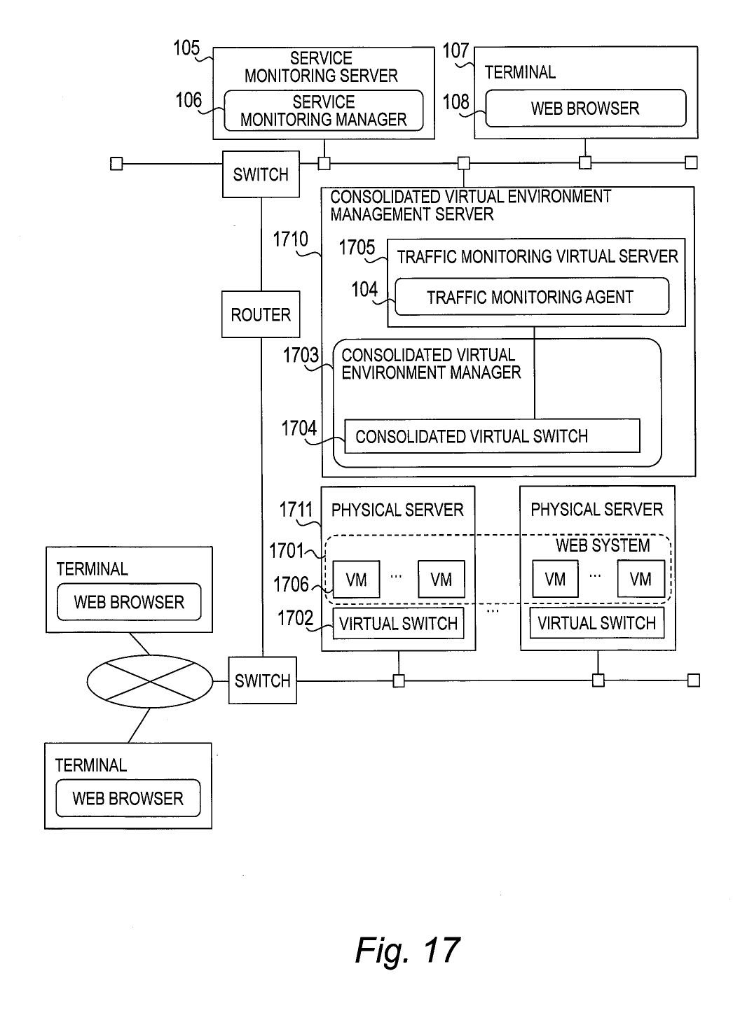

FIG. 17 is a block diagram illustrating a service monitoring system in a case where a web system in Embodiment 2 is implemented with a virtual server.

The service monitoring system in Embodiment 2 includes a service monitoring server 105 and a terminal 107 in Embodiment 1. The difference between the service monitoring system in Embodiment 1 and the service monitoring system in Embodiment 2 is that the service monitoring system in Embodiment 2 has a consolidated virtual environment management server 1710 and at least one physical server 1711.

Each physical server 1711 and the consolidated virtual environment management server 1710 have the same physical configuration as the server illustrated in FIG. 2. The physical server 1711 and the consolidated virtual environment management server 1710 do not need to be equipped with an input device 206 and an output device 207.

Each physical server 1711 has a virtual switch 1702 and runs a plurality of virtual machines (VMs) 1706. The virtual switch 1702 in each physical server 1711 relays communications between the virtual machines 1706 in the physical server 1711 and the virtual machines 1706 in the other physical servers 1711. The virtual machines run on the physical servers 1711 include a virtual machine 1706 having a function of web server, a virtual machine 1706 having a function of application server, and a virtual machine 1706 having a function of DB server.

The web system 1701 in Embodiment 2 is a system implemented with all the virtual machines run on the plurality of physical servers 1711. The web system 1701 provides services to the terminals 107.

The consolidated virtual environment management server 1710 runs a traffic monitoring virtual server 1705 and a consolidated virtual environment management manager 1703. The traffic monitoring virtual server 1705 and the consolidated virtual environment manager 1703 are virtual servers run by the consolidated virtual environment management server 1710.

The consolidated virtual environment manager 1703 manages the physical servers 1711. The consolidated virtual environment manager 1703 can acquire information on the packets sent and received among the plurality of virtual switches 1702 and manage the information about sending and receiving packets among the plurality of virtual switches 1702 as information about sending and receiving packets by a single consolidated virtual switch 1704. Accordingly, the consolidated virtual environment manager 1703 can capture the packets relayed by the consolidated virtual switch 1704 (or the plurality of virtual switches 1702).

The consolidated virtual environment manager 1703 includes the packets captured by the consolidated virtual switch 1704 in an input stream and sends the input stream to the traffic monitoring virtual server 1705.

The traffic monitoring virtual server 1705 performs the same processing as that of the traffic monitoring server 103 in Embodiment 1 on the input stream received from the consolidated virtual environment manager 1703. When the service monitoring server 105 receives a monitored information stream 712 from the traffic monitoring virtual server 1705, it performs the same processing as in Embodiment 1.

Embodiment 2 enables capturing the packets sent and received by the web system 1701 (for example, packets transmitted between a web server and an application server and packets transmitted between the application server and a DB server) in addition to the packets transmitted between the web system 1701 and the terminals 107. As a result, Embodiment 2 can monitor service performance from the communication traffic in the web three tiers, achieving higher accuracy in the monitoring.

As set forth above, this invention has been described in detail with reference to the accompanying drawings; however, this invention is not limited to the specific configuration as described above and includes various modification and equivalent configurations within the scope of the attached claims.

This invention is applicable to a service monitoring system for monitoring the status of a web system providing services.

1. A service monitoring system comprising:
a terminal for sending requests for services;
a monitoring target system for sending responses in accordance with the requests sent from the terminal;
a traffic monitoring server installed between the terminal and the monitoring target systems; and
a service monitoring server connected with the traffic monitoring server,
wherein the traffic monitoring server and the service monitoring server each include a processor and a memory,
wherein the traffic monitoring server receives requests sent from the terminal and responses sent from the monitoring target system,
wherein the traffic monitoring server acquires identifiers of services requested for and corresponding service performance values indicating performance of the monitoring target system providing the services based on the received requests and responses,
wherein the service monitoring server includes a monitoring target service storage unit including a first character string and a value identifying a first group assigned to the first character string,
wherein the service monitoring server receives the identifiers of services and the corresponding service performance values acquired by the traffic monitoring server,
wherein, in a case where a received identifier of a service includes the first character string, the service monitoring server classifies the received corresponding service performance value as a first group based on the monitoring target service storage unit,
wherein the service monitoring server defines a baseline for the first group based on service performance values classified as the first group,
wherein in a case where the service monitoring server receives an identifier and a service performance value of a first service, the identifier of the first service includes the first character string, and the service performance value of the first service is higher than predetermined criteria based on the baseline for the first group, the service monitoring server stores the identifier and the service performance value of the first service to an outlier storage unit,
wherein the service monitoring server determines whether the identifier of the first service includes a common character string other than the first character string based on the outlier storage unit, and
wherein, in a case where a result of the determination indicates that the identifier of the first service includes the common character string other than the first character string, the service monitoring server outputs a second character string including the first character string and the common character string other than the first character string as a proposed character string to be assigned a new second group.

2. The service monitoring system according to claim 1,
wherein, in a case where the output second character string is selected as a character string to be assigned the new second group, the service monitoring server stores the second character string and a value identifying the second group to be assigned to the second character string in the monitoring target service storage unit,
wherein, in a case where the service monitoring server receives an identifier and a service performance value of a first service and the identifier of the first service includes a second character string, the service monitoring server classifies the service performance value of the first service as the second group based on the monitoring target service storage unit, and
wherein the service monitoring server defines a baseline for the second group based on service performance values classified as the second group.

3. The service monitoring system according to claim 1, further comprising a network apparatus for connecting the monitoring target system, the terminal, and the traffic monitoring server,
wherein the network apparatus captures requests sent from the terminal and responses sent from the monitoring target system,
wherein the traffic monitoring server receives stream data including the captured requests and responses to receive the requests sent from the terminal and the responses sent from the monitoring target system,
wherein the service monitoring server receives stream data including the identifiers of services and the corresponding service performance values acquired by the traffic monitoring server to receive the identifiers of services and the corresponding service performance values acquired by the traffic monitoring server, and
wherein the service monitoring server outputs stream data including the proposed character string to be assigned the new group.

4. The service monitoring system according to claim 3,
wherein each of the identifiers of the services includes a URI path including at least one character string and a URI query including at least one character string,
wherein the service monitoring server compares a first URI query included in the identifier of the first service with a second URI query included in the identifier of the second service with respect to each character string broken at a predetermined character based on the outlier storage unit, and
wherein, in a case where a result of the comparison indicates the first URI query includes at least one character string of the character strings included in the second URI and the first character string is a first URI path included in the identifier of the first service, the service monitoring server determines that the identifier of the first service includes the second character string.

5. The service monitoring system according to claim 2, further comprising an output device,
wherein the service monitoring server includes a baseline storage unit for retaining values of a baseline for the first group and values of a baseline for the second group, and
wherein the service monitoring system displays the baseline for the first group defined in a predetermined period and the baseline for the second group defined in the predetermined period on the output device based on the baseline storage unit.

6. The service monitoring system according to claim 5,
wherein the service monitoring server includes a service performance storage unit for retaining statistics calculated based on the service performance values, and
wherein the service monitoring server displays statistics calculated in the predetermined period, the baseline for the first group defined in the predetermined period, and the base for the second group defined in the predetermined period on the output device based on the baseline storage unit and the service performance storage unit.

7. The service monitoring system according to claim 1,
wherein the service monitoring server outputs an alert including the identifier and the service performance value of the first service when storing the identifier and the service performance value of the first service in the outlier storage unit.

8. A service monitoring method performed by a service monitoring system including a terminal for sending requests for services, a monitoring target system for sending responses in accordance with the requests sent from the terminal, a traffic monitoring server installed between the terminal and the monitoring target systems, and a service monitoring server connected with the traffic monitoring server,
the traffic monitoring server including a first processor and a first memory,
the service monitoring server including a second processor and a second memory,
the service monitoring method comprising:
receiving, by the first processor, requests sent from the terminal and responses sent from the monitoring target system;
acquiring, by the first processor, identifiers of services requested for and corresponding service performance values indicating performance of the monitoring target system providing the services based on the received requests and responses;
storing, by the second processor, a first character string and a value identifying a first group assigned to the first character string in a monitoring service storage unit included in the second memory;
receiving, by the second processor, the identifiers of services and the corresponding service performance values acquired by the traffic monitoring server,
classifying, by the second processor, a received service performance value as a first group based on the monitoring target service storage unit in a case where the received identifier of the service corresponding to the service performance value includes the first character string;
defining, by the second processor, a baseline for the first group based on the service performance values classified as the first group;
storing, by the second processor which has received an identifier and a service performance value of a first service, the identifier and the service performance value of the first service to an outlier storage unit in a case where the identifier of the first service includes the first character string and the service performance value of the first service is higher than predetermined criteria based on the baseline for the first group;
determining, by the second processor, whether the identifier of the first service includes a common character string other than the first character string based on the outlier storage unit; and
outputting, by the second processor, a second character string including the first character string and the common character string other than the first character string as a proposed character string to be assigned a new second group in a case where a result of the determination indicates that the identifier of the first service includes the common character string other than the first character string.

9. The service monitoring method according to claim 8, further comprising:
storing, by the second processor, the second character string and a value identifying the second group to be assigned to the second character string in the monitoring target service storage unit in a case where the output second character string is selected as a character string to be assigned the new second group;
classifying, by the second processor which has received an identifier and a service performance value of a first service, the service performance value of the first service as the second group based on the monitoring target service storage unit in a case where the identifier of the first service includes a second character string; and
defining, by the second processor, a baseline for the second group based on service performance values classified as the second group.

10. The service monitoring method according to claim 8,
wherein the service monitoring system further includes a network apparatus for connecting the monitoring target system, the terminal, and the traffic monitoring server,
wherein the network apparatus includes a third processor,
wherein the service monitoring method further comprises:
capturing, by the third processor, requests sent from the terminal and responses sent from the monitoring target system;
receiving, by the first processor, stream data including the captured requests and responses to receive the requests sent from the terminal and the responses sent from the monitoring target system;
receiving, by the second processor, stream data including the identifiers of services and the corresponding service performance values acquired by the traffic monitoring server to receive the identifiers of services and the corresponding service performance values acquired by the traffic monitoring server; and
outputting, by the second processor, stream data including a proposed character string to be assigned the new group.

11. The service monitoring method according to claim 10,
wherein each of the identifiers of the services includes a URI path including at least one character string and a URI query including at least one character string,
wherein the service monitoring method further comprises:
comparing, by the second processor, a first URI query included in the identifier of the first service with a second URI query included in the identifier of the second service with respect to each character string broken at a predetermined character based on the outlier storage unit; and
determining, by the second processor, that the identifier of the first service includes the second character string in a case where a result of the comparison indicates the first URI query includes at least one character string of the character strings included in the second URI and the first character string is a first URI path included in the identifier of the first service.

12. The service monitoring method according to claim 9,
wherein the service monitoring system further includes an output device,
wherein the service monitoring method further comprises:
storing, by the second processor, values of a baseline for the first group and values of a baseline for the second group in a baseline storage unit included in the second memory; and
displaying, by the second processor, the baseline for the first group defined in a predetermined period and the baseline for the second group defined in the predetermined period on the output device based on the baseline storage unit.

13. The service monitoring method according to claim 12, further comprising:
storing, by the second processor, statistics calculated based on the service performance values in a service performance storage unit included in the second memory; and
displaying, by the second processor, statistics calculated in the predetermined period, the baseline for the first group defined in the predetermined period, and the base for the second group defined in the predetermined period on the output device based on the baseline storage unit and the service performance storage unit.

14. The service monitoring method according to claim 8, further comprising:
outputting, by the second processor, an alert including the identifier and the service performance value of the first service when storing the identifier and the service performance value of the first service in the outlier storage unit.
